(19) United States
(12) Patent Application Publication
(10) Pub. No.: US 2024/0426664 A1
(43) Pub. Date: Dec. 26, 2024

(54) AERIAL IMAGING SYSTEM AND METHOD HAVING MULTISPECTRAL AND PANCHROMATIC SENSORS

(71) Applicant: MICASENSE, INC., Seattle, WA (US)

(72) Inventors: Justin Bates MCALLISTER, Seattle, WA (US); Felix DARVAS, Seattle, WA (US); Steven Matthew LARSEN, Seattle, WA (US)

(21) Appl. No.: 18/684,152

(22) PCT Filed: Sep. 2, 2022
(86) PCT No.: PCT/US2022/075938

§ 371 Date: Feb. 15, 2024

Related U.S. Application Data
(60) Provisional application No. 63/240,730, filed on Sep. 3, 2021.

(51) Int. Cl. G01J 3/28; G01J 3/02; G01J 3/36; G01J 5/00; G01J 5/08; G06V 10/143

(52) U.S. Cl. CPC G01J 3/2823; G01J 3/0202; G01J 3/0291; G01J 3/36; G01J 5/0859; G06V 10/143; G01J 2003/2826; G01J 2005/0077

(57) ABSTRACT

The present disclosure is directed to devices and methods for synchronizing capturing of spectral images, capturing of thermal images, and capturing of panchromatic images. A thermal imaging device of an aerial vehicle captures a sequence of thermal images. Capturing of spectral images by a spectral imaging device of the aerial vehicle is synchronized with the capturing of the thermal images. Capturing of panchromatic images is synchronized with the capturing of thermal images. Irradiance data indicative of a background temperature is sensed. A digital surface model of an area of interest is generated based on the sequence of spectral images. An emissivity of a target is estimated and a temperature of a pixel of the digital surface model of the target is estimated based on the sequence of thermal images, the irradiance data indicative of the background temperature and the estimated emissivity of the target.

### BACKGROUND

### Technical Field

The present disclosure is generally directed to generating and processing image streams captured by one or more thermal image sensors together with streams captured by one or more spectral image sensors and streams captured one or more panchromatic image sensors.

### Description of the Related Art

Thermal imaging devices, such as Long-Wave Infrared (LWIR) imagers and other thermal cameras, may be used to capture thermal images of a target. The captured images may be used to estimate the temperature of the target object.

Spectral imaging devices, such as multispectral imaging devices, may be used to capture spectral images of a target. Images acquired by such spectral imaging devices may be utilized to measure or determine different characteristics of the target.

Irradiance sensing devices, such as photo sensors, may be configured to sense irradiance from a light source. The sensed irradiance may be used to process images, such as images received from thermal imaging devices and spectral imaging devices.

Panchromatic imaging devices, such as panchromatic cameras, may be used to capture a large range of light wavelengths, for example, a large portion of the visible spectrum.

### BRIEF SUMMARY

In an embodiment, a device comprises: thermal imaging circuitry, which, in operation, executes a sequence of thermal image capture cycles to capture a sequence of thermal images; spectral imaging circuitry, which, in operation, executes a sequence of spectral image capture cycles to capture a sequence of spectral images; panchromatic imaging circuitry, which in operation, executes a sequence of panchromatic images; and control circuitry, coupled to the thermal imaging circuitry, the spectral imaging circuitry, and the panchromatic imaging circuitry, wherein the control circuitry, in operation, synchronizes execution of spectral image capture cycles by the spectral imaging circuitry with execution of thermal image capture cycles by the thermal imaging circuitry and with the panchromatic image capture cycles of the panchromatic imaging circuitry.

In an embodiment, the device comprises one or more additional spectral imaging circuits, wherein the control circuitry, in operation, synchronizes execution of spectral image capture cycles by the one or more additional spectral imaging circuits with the execution of the thermal image capture cycles by the thermal imaging circuitry and the image capture cycles of the panchromatic imaging circuitry. In an embodiment, the spectral image circuity and the one or more additional spectral image circuits have a common shutter. In an embodiment, the control circuitry, in operation, generates a digital surface model based on the sequence of spectral images. In an embodiment, the control circuitry, in operation, generates the digital surface model based on the sequence of thermal images.

In an embodiment, the control circuitry, in operation, generates a composite pixel map of an area of interest based on the digital surface model. In an embodiment, the control circuitry, in operation, identifies distressed plants based on the composite pixel map. In an embodiment, the control circuitry, in operation, identifies and counts the number of plants or crops based on the composite pixel map. In an embodiment, the control circuitry, in operation, estimates temperatures of pixels or groups of pixels in the composite pixel map. In an embodiment, the control circuity, in operation, estimates pixel conditions based on the composite pixel map and the estimated temperatures. In an embodiment, the control circuitry, in operation, identifies distressed plants based on the composite pixel map and the estimated temperatures. In an embodiment, the control circuitry synchronizes a spectral image capture cycle with every ninth thermal image capture cycle. In an embodiment, the control circuitry synchronizes a panchromatic image capture cycle with every ninth thermal image capture cycle. Other rates of synchronization are envisioned, such as every other thermal image capture cycle. Alternatively, the control circuitry may synchronize the shutter of the thermal image capture device, the spectral image capture device, and the panchromatic image capture device on every hundredth thermal image capture. The range of synchronized captures of thermal, spectral, and panchromatic images can be a simultaneously shutter at every other thermal capture to every hundredth thermal capture. The cycle time can be selected based on the specific operation times of each of the thermal, spectral, and panchromatic imaging devices. In an embodiment, the control circuitry, in operation, identifies conditions consistent with an irrigation leak based on the estimated pixel conditions. In an embodiment, the device is an aerial vehicle.

In an embodiment, a method comprises: executing, by a thermal imaging device, a sequence of thermal image capture cycles to capture a sequence of thermal images; synchronizing execution, by a spectral imaging device, of spectral image capture cycles to capture a sequence of spectral images with execution of thermal image capture cycles by the thermal imaging device; synchronizing execution, by a panchromatic imaging device, of panchromatic image capture cycles to capture a sequence of panchromatic images with execution of the thermal image capture cycles by the thermal imaging device; and generating a digital surface model of an area of interest based on the sequence of spectral images. In an embodiment, the method comprises synchronizing execution of spectral image capture cycles by a plurality of spectral imaging devices with the execution of the thermal image capture cycles by the thermal imaging circuitry. In an embodiment, the method comprises synchronizing execution of panchromatic image capture cycles by one or more panchromatic imaging devices with execution of thermal image capture cycles by the thermal imaging circuitry. In an embodiment, the digital surface model is based on the sequence of thermal images. In an embodiment, the method comprises generating a composite pixel map of the area of interest based on the digital surface model. In an embodiment, the method comprises identifying distressed plants based on the composite pixel map. In an embodiment, the method comprises estimating temperatures of pixels or groups of pixels in the composite pixel map. In an embodiment, the method comprises estimating pixel conditions based on the composite pixel map and the estimated temperatures. In an embodiment, the method comprises identifying irrigation leaks based on the pixel occupancy map and the estimated temperatures. In an embodiment, the method comprises counting a number of distinct objects (e.g., plants, crops, corn husk, apples, etc.) based on the composite pixel map.

In an embodiment, a device comprises: thermal imaging circuitry, which, in operation, executes a sequence of thermal image capture cycles to capture a sequence of thermal images; spectral imaging circuitry, which, in operation, executes a sequence of spectral image capture cycles to capture a sequence of spectral images; panchromatic imaging circuitry, which, in operation, executes a sequence of panchromatic image capture cycles to capture a sequence of panchromatic images; inertial motion sensing circuitry, which, in operation, generates data indicative of relative movement of the device; and control circuitry, coupled to the thermal imaging circuitry, to the spectral imaging circuitry, to the panchromatic imaging circuitry, and to the inertial motion sensing circuitry, wherein the control circuitry, in operation: synchronizes execution of spectral image capture cycles by the spectral imaging circuitry with execution of thermal image capture cycles by the thermal imaging circuitry and with execution of panchromatic image capture cycles by the panchromatic imaging circuitry; and estimates a pose of a thermal image of the sequence of thermal images based on the data indicative of relative movement of the device. In an embodiment, the inertial motion sensing circuitry comprises an accelerometer. In an embodiment, the inertial motion sensing circuitry comprises a gyroscope. In an embodiment, the control circuitry, in operation, generates a digital surface model based on the sequence of spectral images. In an embodiment, the control circuitry, in operation, generates the digital surface model based on the sequence of thermal images. In an embodiment, the control circuitry, in operation, generates the digital surface model based on the estimated pose of the thermal image. In an embodiment, the control circuitry, in operation, identifies and counts a number of distinct objects (e.g., plants, crops, corn husk, apples, etc.) based on the composite pixel map.

In an embodiment, a method comprises: executing, by a thermal imaging device, a sequence of thermal image capture cycles to capture a sequence of thermal images; synchronizing execution, by a spectral imaging device, of spectral image capture cycles to capture a sequence of spectral images with execution of thermal image capture cycles by the thermal imaging device; synchronizing execution, by a panchromatic imaging device, of panchromatic image capture cycles to capture a sequence of panchromatic images with execution of thermal image capture cycles by the thermal imaging device; capturing inertial motion data; estimating a pose of a thermal image in the sequence of thermal images based on the captured inertial motion data; and generating a digital surface model of an area of interest based on the sequence of spectral images. In an embodiment, the method includes identifying and counting a number of distinct objects (e.g., plants, crops, corn husks, apples, etc.) based on the area of interest utilizing at least the sequence of spectral images and the sequence of panchromatic images.

In an embodiment, a device comprises: thermal imaging circuitry, which, in operation, executes a sequence of thermal image capture cycles to capture a sequence of thermal images; spectral imaging circuitry, which, in operation, executes a sequence of spectral image capture cycles to capture a sequence of spectral images; panchromatic imaging circuitry, which, in operation, executes a sequence of panchromatic image capture cycles to capture a sequence of panchromatic images; irradiance sensing circuitry, which, in operation, senses irradiance data indicative of a background temperature; and control circuitry, coupled to the thermal imaging circuitry, to the spectral imaging circuitry, to the panchromatic imaging circuitry, and to the irradiance sensing circuitry, wherein the control circuitry, in operation: synchronizes execution of spectral image capture cycles by the spectral imaging circuitry with execution of thermal image capture cycles by the thermal imaging circuitry and with the execution of panchromatic image capture cycles by the panchromatic circuitry; generates a digital surface model based on the sequence of spectral images; estimates an emissivity of a target; and estimates a temperature of a pixel of the digital surface model based on the sequence of thermal images, the irradiance data indicative of the background temperature, and the estimated emissivity of the target. In an embodiment, the irradiance sensing circuitry comprises a plurality of photo sensors. In an embodiment, the device identifies and counts a number of distinct objects (e.g., plants, crops, corn husk, apples, etc.) utilizing at least the sequence of spectral images and the sequence of panchromatic images.

In an embodiment, a method comprises: executing, by a thermal imaging device, a sequence of thermal image capture cycles to capture a sequence of thermal images; synchronizing execution, by a spectral imaging device, of spectral image capture cycles to capture a sequence of spectral images with execution of thermal image capture cycles by the thermal imaging device; synchronizing execution, by a panchromatic imaging device, of panchromatic image capture cycles to capture a sequence of panchromatic images with execution of the thermal image capture cycles by the thermal imaging device; sensing irradiance data indicative of a background temperature; generating a digital surface model based on the sequence of spectral images; estimates an emissivity of a target; and estimating a temperature of a pixel of the digital surface model based on the sequence of thermal images, the irradiance data indicative of the background temperature and the estimated emissivity of the target.

The present disclosure is directed to at least one embodiment of an aerial vehicle for scanning and imaging an area, which may be utilized in a variety of applications such as to count a number of distinct objects (e.g., plants, crops, corn husks, apples, fruits, etc.). The aerial vehicle includes a sensor (e.g., camera, imaging device, imager, etc.) having one or more spectral imaging devices, one or more panchromatic imaging devices, and one or more thermal imaging devices. The spectral imaging devices capture spectral images, the panchromatic imaging devices capture panchromatic images, and the thermal imaging devices capture thermal images. The spectral, panchromatic, and thermal images may be captured simultaneously with each other. The spectral images may be received by a processor to generate a multispectral image. The spectral images and the thermal images may be utilized to generate a digital surface model (DSM). The spectral images and the panchromatic images may be utilized to determine a pan-sharpened multispectral image. For example, the spectral images may be pan-sharpened by collating each one of the spectral images with a corresponding one of the panchromatic images to generate a plurality of pan-sharpened spectral images. The pan-sharpened spectral images may then be collated by the processor to generate a pan-sharpened multispectral image of the area. The processor may then identify and count the number of distinct objects within the pan-sharpened multispectral image. In some embodiments, the panchromatic images may be utilized to pan-sharpen a multispectral image already generated by collating the spectral images utilizing the processor instead of pan-sharpening each one of the spectral images separately with a corresponding one of the panchromatic images.

The sensor includes a housing having a base portion and a lens portion extending from the base portion. The housing contain one or more spectral imaging devices within the housing to capture the spectral images, one or more panchromatic imaging devices within the housing to capture the panchromatic images, and one or more thermal imaging devices within the housing to capture thermal images. The housing may further contain one or more processors coupled to the one or more spectral imaging devices, the one or more panchromatic imaging devices, and the one or more thermal imaging devices such that the processor may receive the spectral images, the panchromatic images, and the thermal images such that the processor may process and collate these respective images and identify and count a number of distinct objects within the collated images.

In some embodiments, an irradiance sensing device is included onboard the aerial vehicle and irradiance sensing data from the irradiance sensing device may be utilized in conjunction with the spectral images and panchromatic images to determine a reflectance from a target object (such as a plant, subcomponent of the plant, or the like), which may be utilized to accurately identify and, in some cases, count a number of plants. For example, in at least one embodiment, a system is provided that includes a panchromatic sensor and one or more spectral sensors. The spectral response of the spectral sensors lies within the passband of the panchromatic sensor. The system may be configured to implement a method to synchronize the capture of multispectral and panchromatic images to simultaneously acquire the imagery from each, and the panchromatic sensor is of higher spatial resolution than the multispectral imagers. Each of the panchromatic and spectral sensors have a respective spectral radiance response curve.

In some embodiments, an irradiance sensor is included in the system for measuring two or more spectral bands, and two or more of the spectral bands of the irradiance sensor lie within the panchromatic imager spectral response, with a field of regard which is significantly skyward, (including multiple directional sensors to further estimate the direction of the direct irradiance and the value of the diffuse irradiance).

In some embodiments, a computer program is provided which uses two or more of the measurements from the spectral sensor (or irradiance sensor) to estimate the at-sensor irradiance across the panchromatic spectrum with a resolution at least equal to the resolution of the spectral radiance sensor response. In some embodiments, an atmospheric model is generated or utilized to determine the at-target irradiance from the at-sensor irradiance and the sensor location.

In some embodiments, a computer program is provided which combines the estimated spectral irradiance, the panchromatic radiance values from the panchromatic image, and the multispectral radiance values from the multispectral image, to determine the target reflectance for a given pixel in the panchromatic image for each of the multispectral images.

In some embodiments, an imaging device may be mounted to an unmanned aerial vehicle. the imaging device includes a plurality of multispectral sensors and at least one panchromatic sensor. In operation, the unmanned aerial vehicle may be flown at a height of less than 400 feet and the image information acquired by the multispectral sensors and the panchromatic sensor may be utilized to generate pan-sharpened images that have a resolution of 5 cm (or less) per pixel, which is a high resolution image suitable for particular applications, such as identifying and counting plants or even counting subcomponents of plants (e.g., flowers, buds, fruits, etc.). The higher resolution image information acquired by the panchromatic sensor facilitates generation of the pan-sharpened images having suitably high resolution for such applications. Moreover, embodiments provided herein facilitate high resolution image acquisition and generation in a package having a suitably small size to be carried on an unmanned aerial vehicle which may be used, for example, for identifying and counting crops based on images acquired at a height of about 400 feet or less.

### BRIEF DESCRIPTION OF THE SEVERAL VIEWS OF THE DRAWINGS

In the drawings, identical reference numbers identify similar elements unless the context indicates otherwise. The sizes and relative positions of elements in the drawings are not necessarily drawn to scale.

FIG. 1 illustrates an aerial vehicle to obtain thermal, multispectral, and panchromatic images of a target, in accordance with one or more embodiments of the present disclosure.

FIG. 2 illustrates details of an aerial vehicle in accordance with one or more embodiments of the present disclosure.

FIG. 3 is a perspective view of a sensor having thermal imaging, spectral imaging, and panchromatic imaging devices, in accordance with one or more embodiments of the present disclosure.

FIGS. 4 and 5 illustrate example images captured with a sensor, in accordance with one or more embodiments of the present disclosure.

FIG. 6 is a functional block diagram of a sensor or camera having thermal imaging spectral imaging, and panchromatic imaging devices, in accordance with one or more embodiments of the present disclosure.

FIG. 7 is a perspective view of an irradiance sensing device, in accordance with one or more embodiments of the present disclosure.

FIG. 8 illustrates an area within a spectral image captured by a spectral imaging device, in accordance with one or more embodiments of the present disclosure.

FIG. 9 is a flow chart illustrating one example process of generating capturing synchronized thermal images, spectral images and panchromatic images, and using the images to generate a digital surface model of a target area, in accordance with one or more embodiments of the present disclosure.

FIG. 10 illustrates example image capture cycles in accordance with one or more embodiments of the present disclosure.

FIG. 11 is an image captured by a sensor without a panchromatic imaging device.

FIG. 12 is an image captured by the sensor as shown in FIG. 3 with the panchromatic imaging device.

FIG. 13 are two images side by side captured utilizing spectral imaging devices and panchromatic imaging devices.

FIG. 14 is a graph depicting wavelength bands of spectral imaging devices and a panchromatic imaging device.

### DETAILED DESCRIPTION

The present disclosure is directed to devices, systems and methods of generating and processing image streams captured by one or more thermal image sensors together with image streams captured by one or more spectral image sensors and image streams captured by one or more panchromatic image sensors. The one or more thermal image sensors are fixed with respect to the one or more spectral image sensors. The one or more thermal image sensors are fixed with respect to the one or more panchromatic image sensors. In addition, the thermal image sensor, the spectral image sensor, and the panchromatic image sensor are synchronized to capture images concurrently or simultaneously.

The present disclosure is directed to at least one embodiment of an aerial vehicle for scanning an area to identify and count a number of distinct objects (e.g., plants, crops, corn husks, apples, fruits, etc.). The aerial vehicle includes a sensor (e.g., camera, imaging device, imager, etc.) having one or more spectral imaging devices, one or more panchromatic imaging devices, and one or more thermal imaging devices. The spectral imaging devices capture spectral images, the panchromatic imaging devices capture panchromatic images, and the thermal imaging devices capture thermal images. The spectral images may be received by a processor to generate a multispectral image. The spectral images and the thermal images may be utilized to generate a digital surface model (DSM). The spectral images and the panchromatic images may be utilized to determine a pan-sharpened multispectral image. For example, the spectral images may be pan-sharpened by collating each one of the spectral images with a corresponding one of the panchromatic images to generate a plurality of pan-sharpened spectral images. The pan-sharpened spectral images may then be collated by the processor to generate a pan-sharpened multispectral image of the area. The processor may then identify and count the number of distinct objects within the pan-sharpened multispectral image. In some embodiments, the panchromatic images may be utilized to pan-sharpen a multispectral image already generated by collating the spectral images utilizing the processor instead of pan-sharpening each one of the spectral images separately with a corresponding one of the panchromatic images.

The sensor includes a housing having a base portion and a lens portion extending from the base portion. The housing contains one or more spectral imaging devices within the housing to capture the spectral images, one or more panchromatic imaging devices within the housing to capture the panchromatic images, and one or more thermal imaging devices within the housing to capture thermal images. The housing may further contain one or more processors coupled to the one or more spectral imaging devices, the one or more panchromatic imaging devices, and the one or more thermal imaging devices such that the processor may receive the spectral images, the panchromatic images, and the thermal images such that the processor may process and collate these respective images and identify and count a number of distinct objects within the collated images.

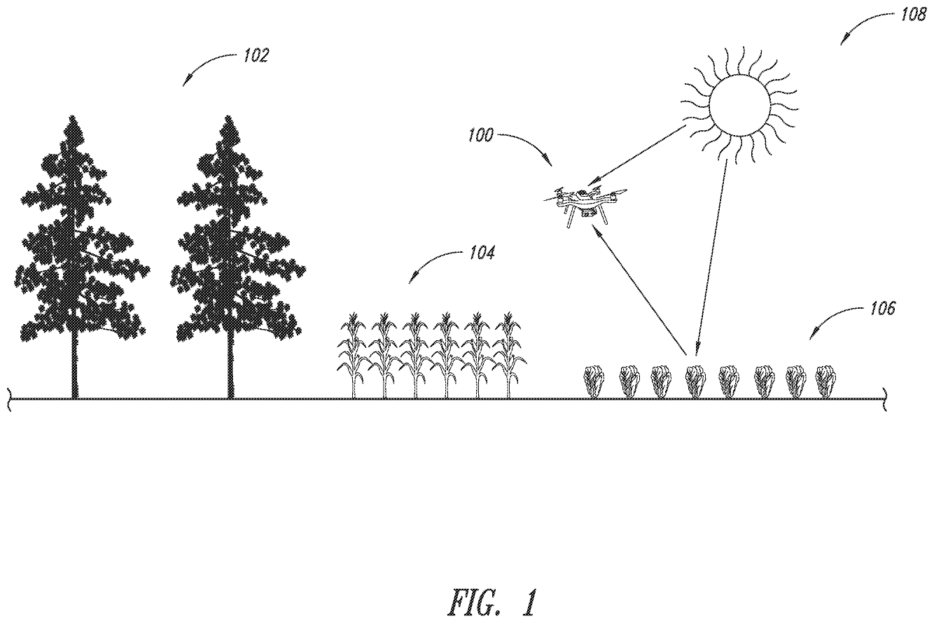

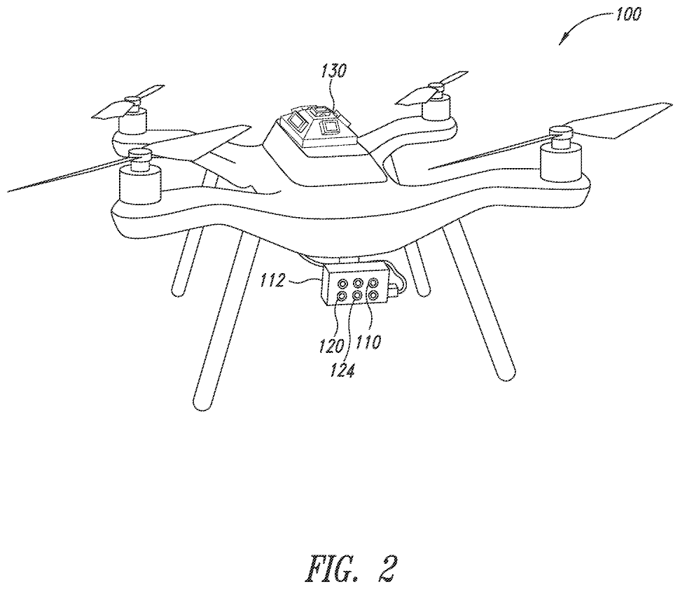

FIG. 1 illustrates an aerial vehicle 100 for simultaneously obtaining thermal, spectral, and panchromatic images, for example, of a ground-based target, in accordance with one or more embodiments, and FIG. 2 illustrates further details of an embodiment of the aerial vehicle 100. Referring to FIGS. 1 and 2, the aerial vehicle 100 includes one or more thermal imaging devices 110, which, in operation, capture thermal images of a physical area or scene (e.g., a target), one or more spectral imaging devices 120, which, in operation, capture spectral images of the physical area or scene (e.g., the target), and one or more panchromatic imaging devices 124, which, in operation, capture panchromatic images of the physical area or scene (e.g., the target). As illustrated, the vehicle 100 also includes one or more irradiance sensing devices 130, which, in operation, sense irradiance levels.

The aerial vehicle 100 may be any type of aerial vehicle, including any rotary or fixed wing aerial vehicle, and may be an unmanned vehicle (as shown in FIG. 1) or manned aerial vehicle, such as an airplane or a drone. Additionally, the aerial vehicle 100 may be an autonomous vehicle, capable of autonomous flight (and autonomous acquisition of image and irradiance information), or may be a piloted vehicle (e.g., flown by a pilot in a manned vehicle, or by a remote pilot of an unmanned vehicle).

The imaged target (e.g., trees 102, crops 104, 106, a field of grass, a body of water or the like) receives irradiance from a light source, such as the sun 108. The target may be one or more distinct objects (e.g., a single tree, a building, a pond, etc.), an area or scene (e.g., a portion of a forest, a portion of a field of crops, a portion of a lake, etc.) or any other target for which the acquisition of an image may be desired. The number of thermal imaging devices or circuits 110 and the number of spectral imaging devices or circuits 120 may vary, for example, based on the type of targets or areas of interest. For example, in storm damage assessment applications (e.g., roof leaks), an aerial vehicle 100 having a single thermal imaging device 110, a single spectral imaging device 120, and a single panchromatic imaging device 124 may be employed, while in agricultural assessment applications, multiple thermal imaging devices 110, multiple spectral imaging devices 120, and multiple panchromatic imaging devices 124 may be employed as greater accuracy or many more images may be captured to provide a more detailed and accurate image of an agricultural field. For example, the thermal images, the spectral images, and the panchromatic images may be captured concurrently and simultaneously and may be utilized by a processor to count or estimate a number of crops, a number of trees, or some other number of distinct objects present within the thermal images, the spectral images, and the panchromatic images. It is envisioned that the systems and methods of the present application may be indoor such that ambient light is incandescent or LED.

The thermal imaging device 110 may be a free-running thermal imager such as a Long-Wave Infrared (LWIR) imager, capable of acquiring thermal images of a target, and may include multiple thermal imagers. Other thermal imaging devices may be employed, such as Short-Wave Infrared (SWIR) imagers, thermopiles, etc., and various combinations thereof.

Images acquired by the thermal imaging device 110 may be utilized to measure or determine different characteristics of the target, such as to estimate the temperature of a target object. The thermal imaging device 110 may be mounted to the aerial vehicle 100 and oriented in any manner as may be desired. For example, the thermal imaging device 110 may be mounted to a lower surface of the aerial vehicle 100 and positioned such that images of ground-based targets may be obtained. The thermal images may be RGB images.

The spectral imaging device 120 may be a multispectral imaging device capable of acquiring spectral images of a target, and may include multiple imagers, with each such imager being tuned for capturing particular wavelengths of light that is reflected by the target. The spectral imaging device 120 may be configured to capture reflected light in one or more of the ultraviolet, visible, near-infrared, and/or infrared regions of the electromagnetic spectrum. The spectral images may be RGB images.

Images acquired by such spectral imaging devices may be utilized to measure or determine different characteristics of the target, such as the chlorophyll content of a plant, an amount of leaf area per unit ground area, an amount or type of algae in a body of water, and the like. In one or more embodiments, the spectral imaging device 120 may be used to determine the reflectance of the imaged target.

The spectral imaging device 120 may be mounted to the aerial vehicle 100 and oriented in any manner as may be desired. For example, the imaging device 120 may be mounted to a lower surface of the aerial vehicle 100 and positioned such that images of ground-based targets may be obtained.

The panchromatic imaging device 124 may be a panchromatic camera capable of acquiring panchromatic images of a target. The panchromatic imaging device 124 may be sensitive to light of all colors in the visible spectrum. In other words, the panchromatic imaging device 124 may be sensitive to blue light as well as sensitive to red light and to any visible light between the blue and red ends of the visible light spectrum.

Images acquired by such panchromatic imaging device 124 may be high resolution images relative to the thermal images and the spectral images captured by the thermal imaging device 110 and the spectral imaging device 120. The panchromatic images captured by the panchromatic imaging device 124 may be combined or collated with those captured by the thermal imaging device 110 and the spectral imaging device 120 by a processor. These high resolution panchromatic images captured by the panchromatic imaging device 124 may be utilized to count a number of a specified plant or crop within the high resolution panchromatic images. For example, a processor may receive the panchromatic images captured by the panchromatic imaging device 124, and, utilizing these high resolution panchromatic images, the processor may count the number of crops (e.g., number of corn husks, number of flowers, number of apples, etc.), may count the number of trees (e.g., fir trees, fruit trees, etc.), or may count a number of distinct objects within the panchromatic images.

In some embodiments, these high resolution panchromatic images captured by the panchromatic imaging device 120, the thermal images captured by the thermal imaging device 110, and the spectral images captured by the spectral imaging device 120 may be utilized to count a number of a specified plant or crop within these images. For example, a processor may receive the thermal images, the spectral images, and the panchromatic images captured by the thermal imaging device 110, the spectral imaging device 120, and the panchromatic imaging device 124, and, utilizing these respective images, the processor may count the number of crops (e.g., number of corn husks, number of flowers, number of apples, etc.), may count the number of trees (e.g., fir trees, fruit trees, etc.), or may count a number of distinct objects within the panchromatic images, thermal images, and the spectral images, which may have been collated together before this counting process. For example, in some embodiments, the processor may receive multispectral data from the spectral images together with the panchromatic data from the panchromatic images to count the number of distinct objects. This process of utilizing the panchromatic data from the panchromatic images may be referred to as pan-sharpening in which the panchromatic data sharpens the accuracy and detection of the crops to be counted due to the high resolution nature of the panchromatic images relative to the spectral images and the thermal images. Pan-sharpening may generally refer to a process of merging or collating high-resolution panchromatic and lower resolution multispectral imagery to create a single high-resolution image.

As illustrated, a sensor 112 houses the thermal imaging device 110, the spectral imaging device 120, and the panchromatic imaging device 124. The sensor 112 is mounted to a lower surface of the aerial vehicle 100. The thermal imaging device 110, the spectral imaging device 120, and the panchromatic imaging device 124 may acquire thermal, spectral images, and panchromatic images simultaneously. As discussed earlier, the sensor 112 includes a processor or circuitry (not shown) that is coupled to the thermal imaging device 110, to the spectral imaging device 120, and to the panchromatic imaging device 124. The processor is configured to operate shutters of each of the thermal, spectral, and panchromatic imaging devices 110, 120, 124, respectively, in a manner to robustly capture thermal, spectral, and panchromatic data such that the data can be processed and collated for a user to understand more about the environment they are evaluating with the vehicle 100 utilizing the thermal imaging device 110, the spectral imaging device 120, and the panchromatic imaging device 124.

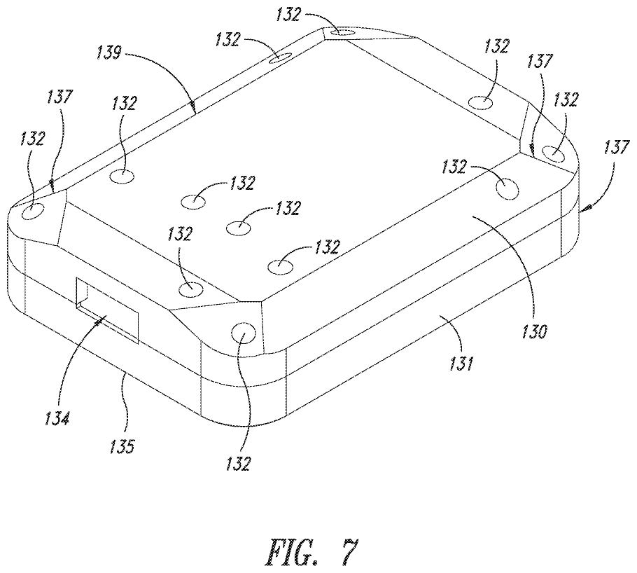

The irradiance sensing device 130 may be mounted to an upper surface of the aerial device 100, and includes a plurality of photo sensors configured to simultaneously sense irradiance from a light source, such as the sun 108, at various different orientations with respect to the light source. The irradiance sensing device 130 is described in more detail with respect to FIG. 7 below.

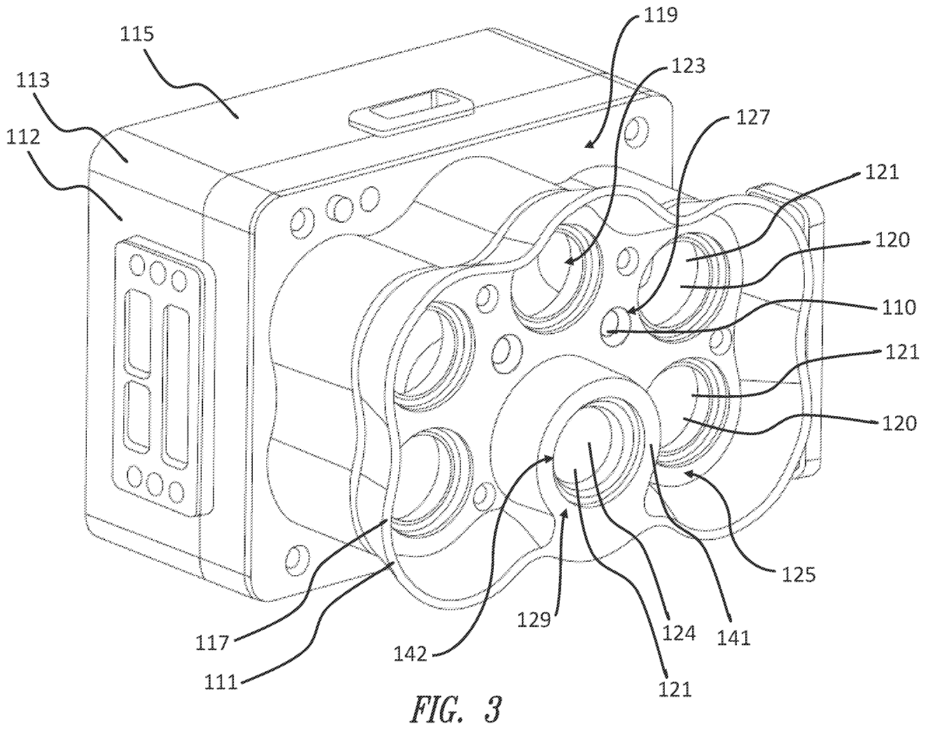

FIG. 3 shows a perspective view of an alternative embodiment of a sensor 112 having at least one thermal imaging device 110, at least one spectral imaging device 120, and at least one panchromatic imaging device 124, in accordance with one or more embodiments of the present disclosure. As illustrated, the sensor 112 has two thermal imaging devices 110, five spectral imaging devices 120, and one panchromatic imaging device 124. In some embodiments, the sensor 112 may have a plurality of panchromatic imaging devices 124. In other words, there may be more than one panchromatic imaging device 124 (e.g., two panchromatic imaging devices, three panchromatic imaging devices, etc.) The five spectral imaging devices may capture spectral images in different image bands (e.g., blue, green, red, red edge and near infrared bands). The two thermal imaging devices 110 may capture thermal images in the infrared bands. The panchromatic imaging device 124 may capture panchromatic images including all wavelengths of the visible light spectrum. In some embodiments, the panchromatic imaging device 124 covers collective wavelengths of the spectral imaging device(s) 120. In other words, the panchromatic imaging device 124 may collect wavelengths that are the same as (or which overlaps) each one of the respective wavelengths or wavelength bands collected by each one of the spectral imaging devices 120 as shown in FIG. 3. The thermal imaging devices 110, the spectral imaging devices 120, and the panchromatic imaging device 124 as illustrated are rigidly positioned with respect to each other. In a typical sensor 112, the thermal imaging devices 110 may have a larger field of view and a lower resolution than the spectral imaging devices 120. For example, a thermal imaging device may have a resolution of 160 by 120 thermal pixels and a field of view of 57 degrees by 44 degrees, while a spectral imaging device may have a resolution 2064 by 1544 pixels and a field of view of 48 degrees by 37 degrees. Due to the higher resolution of the spectral images, it typically takes longer to write a captured spectral image to memory. Thus, the thermal imaging devices 110 in practice may have a faster operating cycle than the spectral imaging devices 120.

The panchromatic imaging device 124 may have very high spatial resolution as compared to the thermal imaging devices 110 and the spectral imaging devices 120. For example, a panchromatic imaging device may have a resolution range of less than 1.97-inches/pixel (5-centimeters/pixel) when the aerial vehicle 100 is at 400-ft of elevation. In some embodiments, a panchromatic imaging device may have a resolution of 0.984-inches/pixel (2.5-centimeters/pixel) when the aerial vehicle 100 is at 400-ft of elevation. In other words, each pixel may be representative of a 0.984-inch distance (e.g., in both length and height) when at 400-ft elevation. In yet some other embodiments, the panchromatic imaging device may have resolution less than 0.984-inches/pixel (2.5-centimeters/pixel). While the thermal imaging devices 110 and the spectral imaging devices 120 may have a lower resolution than the panchromatic imaging device 124, the thermal imaging devices 110 and the spectral imaging devices 120 may include thermal and spectral information that may not be readily available utilizing the panchromatic imaging device 124. Alternatively, the panchromatic imaging device 124 may have panchromatic information that may not be readily available utilizing the thermal imaging devices 110 and the spectral imaging devices 120. The panchromatic imaging device 124 may have a resolution twice the resolution of the spectral imaging devices 120 and the thermal imaging devices 110.

The combination and utilization of the thermal imaging devices 110, the spectral imaging devices 120, and the panchromatic imaging device 124 may allow the processor to utilize information from each of the thermal images, the spectral images, and the panchromatic images captured by the thermal, spectral, and panchromatic imaging devices 110, 120, 124, respectively, to carry out functions and analysis utilizing the information in the captured thermal, spectral, and panchromatic images. For example, the panchromatic images, the spectral images, and the thermal images may be utilized by the processor such that the processor may accurately identify and count the number of plants (e.g., number of corn husks, number of apples, number of trees, number of flowers, etc.) within the images received by the processor, determine the temperature of the plants, and determine other characteristics of the plants.

The processor may accurately identify and count the number of crops within the panchromatic images since the panchromatic images have the high resolution as discussed earlier. The panchromatic images may be utilized to count the number of crops (e.g., corn, apples, etc.) as generally a fully grown and ripe corn is larger than 0.984-inches or a fully grown apple is larger than 0.984 inches. The processer may utilize the panchromatic image and generate a point map having a plurality of points of which each point is representative of a piece of corn, an apple, or some other like type of vegetable or fruit crop to be counted. For example, the processor may be able to count smaller crops with a height or diameter of approximately 2-inches to 4-inches such that the processor may be able to count crops that are not yet fully grown.

In some embodiments, the spectral imaging devices 120, and the panchromatic imaging device 124 facilitate accurate identification and counting of subcomponents of plants or agricultural products, such as individual flower blossoms on a tree or plant, individual fruits or vegetables on a tree or plant, leaves, buds, or other subcomponents of plants, or the like.

The sensor 112 includes a housing 113 that encloses various circuits, including a processor, a power supply, such as a battery, a transceiver or other communication means, such as a wire or wireless transmission circuitry. The housing 113 includes a base portion 115 and a lens portion 117 that extends away from a surface 119 of the base portion. The lens portion 117 includes five lenses 121 positioned in openings 123 through a surface 125 that is spaced outward from the surface 119. Each lens is recessed into the corresponding opening 123 such that a curvature of each lens is recessed from the surface 125. In other embodiments, the curvature of each lens or of some of the lenses may be equal to or extending past the surface 125.

The lens portion 117 protrudes outward from the base portion 115. The lens portion 117 includes a boundary portion 111 that extends away from the surface 125. The boundary portion 111 is around the lenses 121 and the thermal imaging devices 110. The boundary portion 111 may guide light entering the lenses 121 to be captured by the thermal imaging devices 110 and the spectral imaging devices 120.

Within the lens portion 117 and coupled to the base portion 115 are the spectral imaging chips or packages that are aligned with ones of the respective lenses 121. Each one of the spectral imaging chips or packages may be aligned with a corresponding one of the respective lenses 121. The lenses 121 are rigidly positioned within the housing 113. A first spectral imaging device is centrally positioned within the lens portion 117. Two spectral imaging devices are to the right of the centrally positioned spectral imaging device and two spectral imaging devices are to the left of the centrally positioned spectral imaging device. The thermal imaging devices 110 are aligned with holes 127 in the surface 125. A surface 129 is spaced outward with respect to the surface 125. The surface 125 is between the surface 129 and the surface 119. In other words, the surface 125 is recessed within the lens portion 117.

The surface 129 may be a surface of a protrusion 141 that protrudes outward from the surface 125. The panchromatic imaging device 124 is aligned with an opening 142 extending into and through the protrusion 141. One of the lenses 121 is within the opening 142 such that light may readily pass into and through the lenses 121 in the opening 142 to be captured by the panchromatic imaging device 124. The panchromatic imaging device is positioned between the two spectral imaging devices 120 at the right hand side and the left hand side of the lens portion 117. Based on the orientation as shown in FIG. 3, the panchromatic imaging device 124 is below the central spectral imaging device 120. The protrusion 141 may be a portion of the boundary portion 111.

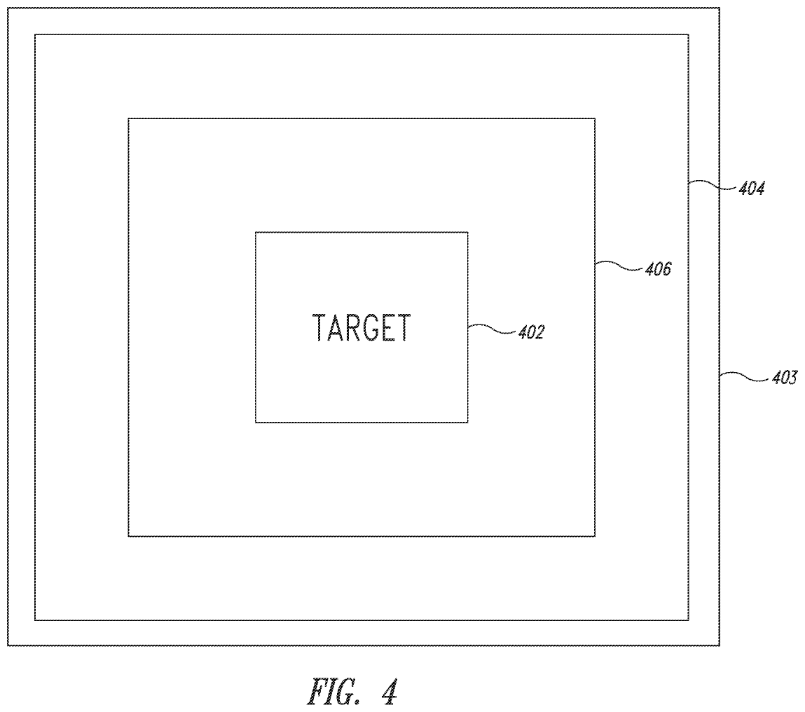

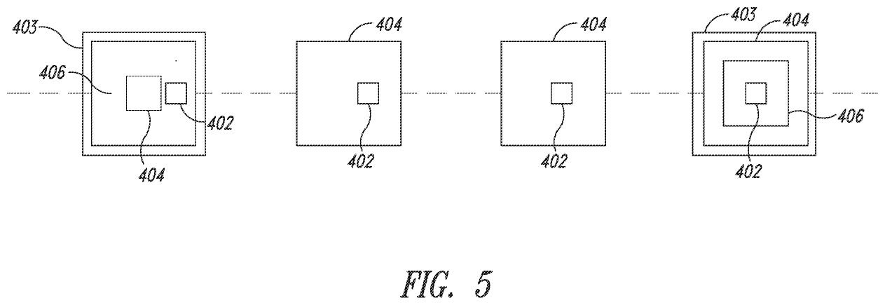

FIGS. 4 and 5 conceptually illustrate example images that may be captured with a sensor, such as the sensor 112 of FIG. 3, in accordance with one or more embodiments of the present disclosure. For ease of illustration, FIGS. 4 and 5 illustrate images captured using a single thermal imaging device 110, from a single spectral imaging device 120 of the sensor 112, and from a single panchromatic imaging device 124. In practice, images may be captured by all of the thermal imaging devices 110 spectral imaging devices 120, and the panchromatic imaging device 124 of the sensor 112. The thermal imaging device 110 captures thermal images 404, which include one or more targets 402, the spectral imaging device 120 captures spectral images 406, which include the target 402, and the panchromatic imaging device 124 captures panchromatic images, which include the target 403. A target may be a feature, such as an object or a point or feature of an object, an individual pixel (e.g., a thermal pixel, a spectral pixel), a group of pixels of a defined size (e.g., a four by four group of pixels), or a set of pixels associated with a feature, such as an object or a point of an object.

FIG. 4 illustrates a single thermal image 404 captured by the thermal imaging device 110, a single spectral image 406 captured by the spectral imaging device 120, and a single panchromatic image 403 captured by the panchromatic imaging device 124. The single thermal image 404, the single spectral image 406, and the panchromatic image 403 overlap with each other as shown in FIG. 4.

FIG. 5 illustrates a series of thermal images 404, spectral images 406, and panchromatic images 403 captured by the thermal imaging device 110, the spectral imaging device 120, and the panchromatic imaging device 124 as the sensor 112 moves by the target 402. As illustrated, the thermal imaging device 110 has a fixed field of view which is broader than the fixed field of view of the spectral imaging device 120, and the panchromatic imaging device 124 has a fixed field of view which is more broad then the field of view of the thermal imaging device 110 and the spectral imaging device 120. In some embodiments, the panchromatic imaging device 124 may have a fixed field of view which is less broad than the fixed field of view of the thermal imaging device 110, may have a fixed field of view less broad than the fixed field of view of the spectral imaging device 120 and more broad than the fixed field of view of the thermal imaging device 110, may have a fixed field of view the same as the fixed field of view of the spectral imaging device 120, or may have a fixed field of view the same as the thermal imaging device 110.

As the thermal imaging device 110 in practice has a faster image capture cycle time (typically due to the lower resolution), more thermal images 404 are captured by the thermal imaging device 110 than spectral images 406 are captured by the spectral imaging device 120 and panchromatic images 403 are captured by the panchromatic imaging device 124 as shown in FIG. 5. In other words, the thermal images 404 have a higher spatial sampling frequency than the spectral images 406 and the panchromatic images 403, in addition to being captured at different wavelengths. As illustrated, four thermal images 404 are captured by the thermal imaging device 110 whereas two spectral images and two panchromatic images are captured by the spectral imaging device 120 and the panchromatic imaging device 124, respectively, during a pass over the target 402 by the sensor 112. In practice, a thermal imaging device 110 may be able to capture eight or more thermal images 404 in the same time period in which the spectral imaging device 120 and the panchromatic imaging device 124, respectively, capture a single spectral image 406 and a single panchromatic image 403.

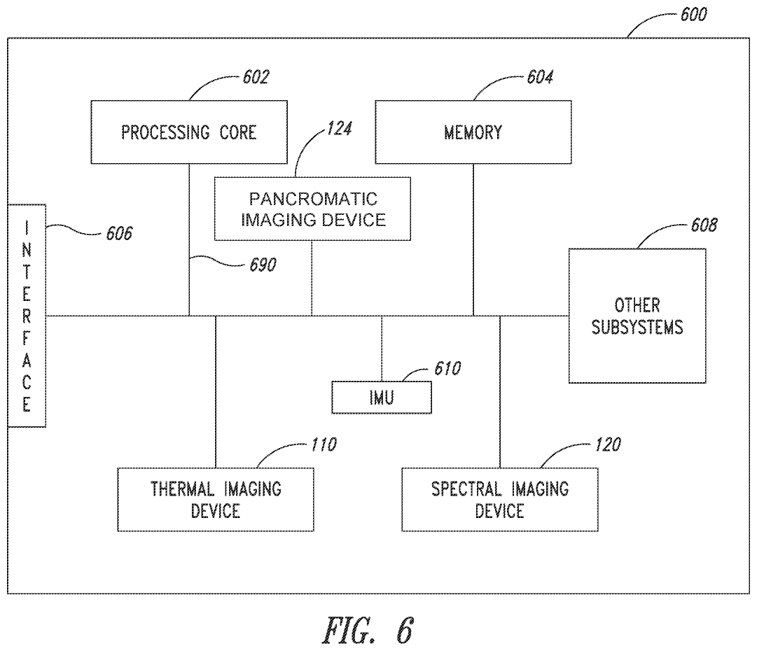

FIG. 6 is a functional block diagram of an embodiment of a sensor 600, which may be employed, for example, as the sensor 112 of FIGS. 1-3, to capture images of one or more targets. The sensor 600 includes one or more thermal imaging devices 110, which, in operation, capture thermal images, one or more spectral imaging devices 120, which, in operation, capture spectral images, and one or more panchromatic imaging devices 124, which, in operation, capture panchromatic images. As illustrated, the system 600 comprises one or more processing cores or processors 602, and one or more memories 604, which may be used in operation to implement the functionality of the sensor 600 (e.g., to control the thermal imaging devices 110, the spectral imaging devices 120, and the panchromatic imaging devices 124, to store and process thermal image data, spectral image date, panchromatic image data, etc.), for example, by executing instructions stored in the memory 604. The system 600 as illustrated also comprises one or more bus systems 606, and may include additional circuitry 608, such as power supplies, etc., which are omitted for ease of illustration. The system 600 also includes one or more inertial measurement units (IMU) 610, such as a gyroscope or accelerometer, which may, in operation, generate position change information as the aerial vehicle 100 captures images of a target.

Embodiments of the sensor 600 may comprise more or fewer circuits than illustrated, and circuits may be combined and separated into additional circuits in various manners. For example, some embodiments of the sensor 600 may incorporate an irradiance sensing device (see irradiance sensing device 130 of FIG. 1). In some embodiments, the sensor 600 may be configured to couple to an external irradiance sensing device. Some embodiments may include telecommunication circuitry (e.g., wifi or cellular), or include such functionality in the interface 606.

In operation, a thermal image 404 generated by the thermal imaging device 110 of the sensor 112 may be used to estimate the temperature of individual pixels of a target. By combining multiple thermal images 404, further considering the spectral images 406 of the target generated by one or more of the spectral imaging devices 120, and further considering the panchromatic images 403 of the one or more of the panchromatic images 124, an increase in the spatial resolution of the temperature estimates may be obtained.

The spectral images 406 may be used, for example, to estimate an emissivity of the target, and the emissivity estimate may be used with the measured temperature information from the thermal images 404 to estimate a temperature of the target. Emissivity is a property of a material of a surface and is a ratio of the energy radiated from a materials surface to that of a blackbody. A perfect emitter (blackbody) has an emissivity of 1 and emits longwave radiation that is equal to its temperature. A perfect thermal mirror has an emissivity of 0. Other materials have an emissivity between 0 and 1. A material with an emissivity less than 1 emits radiation proportional to its temperature. Glass is opaque to longwave radiation, and reflects more than it emits. To estimate the temperature, the emissivity is estimated.

A spectral image 406 may be used to identify target objects and to detect conditions of the target object, such as whether a plant is under stress, whether pipes under a field are leaking, etc. A 3-D digital surface model (DSM) may be generated using multiple spectral images 406 captured as the aerial vehicle 100 moves over the target. Combining spectral image data from a spectral image 406 with thermal image data from one or more thermal images 404 may facilitate generating more accurate estimates of the conditions of a target. The thermal images 404 may be used in combination with the spectral images 406 to generate the DSM. The DSM is a representation of the surface of the earth or environment which is being imaged. The DSM represents elevation differences and reflectance of the objects in the environment. Temperature information of the objects and the environment are incorporated in the DSM based on the thermal images.

Also, data from the irradiance sensing device 130 may be used to estimate the background temperature (e.g., the temperature of the sky). The estimated background temperature information may be used to adjust or correct the measured temperatures of the pixels of the target, increasing the accuracy of temperature estimates and of any condition data based in part on temperature estimates.

A panchromatic image 403 may be used to accurately determine positions of target objects and distinctly identify and determine the number of target objects (e.g., number of plants, number of corn husks, number of apples, number of flowers, etc.) within the panchromatic image 403. A map may be generated using multiple panchromatic images 403 captured as the aerial vehicle 100 moves over the target objects. The map may include points representing a corresponding one of the target objects by each one of the points being aligned with a center of a corresponding one of the target objects. These points on the map generated utilizing the panchromatic images may be counted by a processor to determine the number of crops within an agricultural field.

In some embodiments, the panchromatic image 403 may be utilized along with the thermal images 404 and the spectral images 406 to count the number of target objects (e.g., plants) as well as determine thermal characteristics and health of the target objects (e.g., plants). For example, the panchromatic images 403 provide more accurate positioning of the target objects within the panchromatic images 403 relative to the thermal images 404 and the spectral images 406 such that the number of target objects may be quickly and accurately estimated or counted, whereas the thermal image and the spectral images may be utilized either alone or together to generate a digital surface model and estimate and determine the temperature of each point on the digital surface model.

FIG. 7 shows a perspective view of an irradiance sensing device 130, in accordance with one or more embodiments of the present disclosure. The irradiance sensing device includes a plurality of photo sensors 132 configured to simultaneously sense irradiance from a light source, such as the sun (see FIG. 1), at various different orientations with respect to the light source. As illustrated, the irradiance sensing device 130 includes an interface 134, which may, in operation, be coupled to a processing device, such as the processing core 602 of sensor 600 via the interface 606 of FIG. 6.

The photo sensors 132 may be multi-spectral downwelling light sensors (DLS). Data or images from the photo sensors 132 may be used to estimate the temperature distribution of the sky during aerial thermography. The photo sensors 132 may measure the angle and diffusivity ratio of light paths. A model of the hemispherical incoming irradiance may be generated based on the measured information and used to estimate a temperature of the sky.

The photo sensors 132 measure solar irradiance in radiometric remote sensing applications. Irradiance from a light source, such as the sun, may be simultaneously sensed by a plurality of photo sensors arranged at differing orientations on an irradiance sensing device. Components of the irradiance, such as the direct and scattered components and the incidence angle, may thus be determined, and utilized to compensate or normalize images of a target that are acquired at the same time by an imaging device.

By simultaneously sensing irradiance by multiple photo sensors having different orientations, it is possible to determine particular characteristics of the light source, such as the direct and scattered components of solar irradiance, as well as an angle of incidence a of the solar irradiance. Moreover, the irradiance sensing device 130 may sense irradiance at the same time as images are acquired by the imaging device, which enables normalization or compensation of the acquired images to account for variations in received irradiance by the imaged target. For example, an image of a target acquired by the imaging device 100 (e.g., aerial vehicle 100) on a cloudy day can be correlated to an image acquired of the same target on a cloudless day, by accounting for the differences in the irradiance sensed by the irradiance sensing device 130 at the time of acquiring each image (thermal and/or spectral).

The irradiance sensing device 130 includes a plurality of irradiance sensing surfaces arranged at different orientations and photo sensors configured to receive and sense varying amounts or components (e.g., direct and scattered components) of irradiance from a light source such as the sun. The irradiance sensing device 130 can be attached to the aerial vehicle and communicatively coupled to the thermal and spectral imaging devices.

With reference to FIG. 7, the irradiance sensing device 130 includes a housing 131 which forms outer surfaces of the device 130. In some embodiments, the housing 131 may include two or more pieces that are securable to one another by any suitable elements, including, for example, by one or more of a fastener, adhesive material, hinges, or the like. In some embodiments the housing 131 includes a top enclosure 133 and a bottom enclosure 135.

The top enclosure 133 includes a plurality of inclined surfaces 137 which extend in different orientations between respective edges and an upper surface 139 of the top enclosure 133. A plurality of irradiance sensing openings extend through the inclined surfaces 137 and/or the upper surface 139. In some embodiments, each of the inclined surfaces 137 and the upper surface 139 includes at least one irradiance sensing opening aligned with one of the photo sensors 132.

The plurality of photo sensors 132 is arranged on an internal board, which may be a mounting structure for mounting the photo sensors, and in some embodiments carries various electronic circuitry, components, or the like included in the irradiance sensing device 130.

Light pipes are positioned in the irradiance sensing openings and aligned with each photo sensor. The light pipes may be any physical structure capable of transmitting or distributing received irradiance from outside of the housing 131 into an interior of the housing 131, and more particularly, toward each of the photo sensors 132. The light pipes may have a hollow structure or a solid structure. In some embodiments, the light pipes are not included.

The photo sensors 132 may be configured to sense irradiance having various different wavelengths. For example, in one or more embodiments, the photo sensors includes one or more broadband photo sensors that sense ambient light or irradiance and one or spectral sensors that sense light having specific wavelengths or ranges of wavelengths across the electromagnetic spectrum. In some embodiments, broadband photo sensors are configured to sense light through the irradiance sensing openings of the inclined surfaces 137, while spectral sensors are configured to sense light through the irradiance sensing openings on the upper surface 139 of the top enclosure 133.

Various electronic circuitry (such as one or more application specific integrated circuits, computer-readable memory and the like) for processing and/or storing received signals (e.g., signals indicative of the sensed irradiance), may be attached to the internal board.

Each of the photo sensors 132 may be communicatively coupled to a processor (e.g., wirelessly coupled, or coupled by one or more electrical wires or cables) and, during operation, may communicate signals (e.g., one or more signals indicative of the sensed irradiance) to or from the processor. The processor may be configured to perform any of the functions described herein, including, for example, determining directed and scattered components of sensed irradiance, receiving acquired images, determining the reflectance of a target object based on determined direct and scattered components of sensed irradiance and an acquired image, storing information or causing information to be stored, correlating information, determining orientation of the irradiance sensing device 130, navigational functions, and so on.

In some embodiments, the present disclosure provides a device including a structure, and a plurality of photo sensors coupled to the structure. The photo sensors have different sensing orientations with respect to one another, and each of the photo sensors, in use, receives irradiance at a respective one of the plurality of sensing orientations. The different sensing orientations include at least five different sensing orientations. In some embodiments, the photo sensors have sensing surfaces that are arranged at the different sensing orientations. In some embodiments, a housing has a plurality of surfaces that have the different sensing orientations, and the photo sensors receive light incident on the surfaces. In some embodiments, the housing may have a hemispherical or spherical shape, with light being incident at a plurality of different sensing orientations on the housing, and the plurality of photo sensors receive light incident on different portions of the hemispherical or spherical housing.

The sensing orientations of the photo sensors may be different from one another in terms of angle or position with respect to any reference point. For example, the sensing orientations may have different angles with respect to a reference point, which may be measured, for example, from a center of the structure to which the photo sensors 132 are attached. Each of the photo sensors 132 may be configured to receive light incident at a particular surface area or region (e.g., at a surface area of the openings in the top enclosure 133 of the device 130). The amount of data generated by the thermal image sensors 110, the spectral image sensors 120, the panchromatic image sensors 124, and the optional irradiance sensing device 130, may be quite substantial, and the processing, memory and power requirements associated with turning such a large of volume of data into a useful output (e.g., images of a target showing estimated temperatures of the target or portions thereof, images showing estimated conditions of a target, etc.) may similarly be quite substantial. The processing may be complicated by the differences in resolution and field of view between the thermal images, the spectral images, and the panchromatic image sensors 124, and the free-running of the thermal imaging devices 110.

One way to reduce the processing overhead is to discard most of the thermal images 404 generated by the thermal imaging device 110. For example, for each capturing of a spectral image 406 and a panchromatic image 403, one thermal image 404 may be captured, and the rest of the thermal images 404 may be discarded. With reference to FIGS. 5 and 6, only the thermal images 404 captured at the same time as a spectral image 406 and the panchromatic image 403 may be saved to memory 604. This reduces the memory requirements of the sensor 112, and may reduce the processing requirements associated with turning the data into a useful output. However, resolution of the thermal information is reduced by discarding some of the thermal images 404.

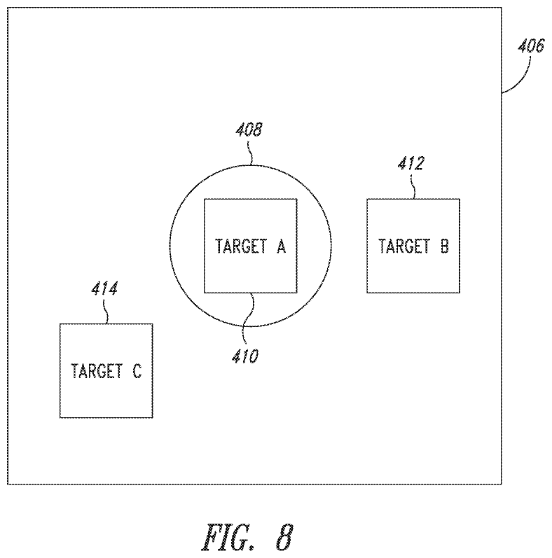

Another way to reduce the processing overhead is to limit the amount of information from the spectral images 406 that is saved and used to process the images (e.g., the amount of information used to generate the DSM). In the spectral images 406, only data from a central portion of the image 406 may be saved on the assumption that data in this portion of the image is the most useful. FIG. 8 illustrates this concept. The data within area 408 of the image 406 may be saved, and the data outside of area 408 may be discarded. The size of the area 408 may be determined based on the Nyquist theorem. Saving only the best part of the data reduces memory requirements and may also decrease the spectral image capture cycle time. Thus, in the spectral image 406 of FIG. 8, data for target A 410 may be saved. However, data for target B 412 and data for target C 414 would be lost, which may reduce the accuracy of the DSM and the resolution of any useable output information, such as maps of target conditions. When all or more of the spectral image data than the data within area 408 is stored and used to generate the DSM, oversampling of targets is facilitated, which results in higher resolution images due to the spatial overlap in the spectral images. For example, data related to target B 412 and target C 414 is available from more of the spectral images.

Due to the free-wheeling of the thermal imaging device 110, thermal images 404 captured by one or more of the thermal imaging devices 110 are not synchronized with spectral images 406 and the panchromatic images 403 captured by one or more of the spectral imaging devices 120 and by one or more of the panchromatic imaging device 124. This increases the complexity of generating the DSM when thermal image data is combined with spectral image data.

To avoid this increase complexity, capturing of spectral images 406 by a spectral imaging device 120 may be synchronized to the capturing of thermal images by a thermal imaging device 110 and capturing of panchromatic images by a panchromatic image device 124. This may facilitate capturing all of the thermal images and using more of the data of the spectral images and the panchromatic images, which in turn facilitates oversampling for the spectral image, the thermal image, and the panchromatic image modeling. The synchronizing may, for example, be based on the capture cycle time of the spectral imaging device 120, the capture cycle time of the thermal imaging device 110, and the capture cycle of the panchromatic imaging device 124. Based on the spectral, thermal, and panchromatic image capture cycles, a number of cycles n of the thermal imaging device 110 may be determined, capturing of an image by the spectral imaging device 120 may be triggered every n cycle of the thermal imaging device, and capturing of an image by the panchromatic imaging device 124 may be triggered every n cycle of the thermal imaging device along with the spectral imaging device 120. A spectral image capturing device 120 and a panchromatic capturing device 124 may capture an image frame every second, a thermal image capture device 110 may capture 9 images a second. Thus, in such a case n may be set at 9.

When one or more spectral imaging devices 120 and one or more panchromatic imaging devices 124 are synchronized to one or more thermal imaging devices 110, an image capture cycle time of the slowest of the spectral imaging devices 120 and the panchromatic imaging devices 124 may be used to determine the number of cycles n of the thermal imaging device 110 used to trigger capturing of spectral images 406 or the capturing of the panchromatic images 403 by the one or more spectral imaging devices 120 or the one or more panchromatic imaging devices 124. To facilitate synchronizing of the spectral images 406, the thermal images 404, and the panchromatic images 403 to each other captured by cycle n of the thermal imaging device 110, a common shutter may be employed by the one or more spectral imaging devices 120 and the one or more panchromatic imaging devices 124, or the spectral imaging devices 120 and the panchromatic imaging device 124 may employ fast shutters. This facilitates the spectral image sensors and the panchromatic image sensors having an overlapping recovery time. The common shutter may be facilitated by the processing core 602, controlling the timing of each sensor in the array of thermal, spectral, and panchromatic imaging devices 110, 120, 124, respectively.

When one or more spectral imaging devices 120 and one or more panchromatic imaging devices 124 are synchronized to one or more thermal imaging devices 110, an image capture cycle time of the slowest of the thermal imaging devices 110 may be used to determine the number of cycles n of the thermal imaging device 110 used to trigger capturing of spectral images 406 and the panchromatic images 403 by the one or more spectral imaging devices 120 and the one or more panchromatic imaging devices 403. The thermal imaging devices 110 may be synchronized to each other, and a common thermal image cycle time may be used to determine the number of cycles n, etc.

Synchronizing capturing of spectral images 406 and the panchromatic images 403 by one or more of the spectral imaging devices 120 and one or more of the panchromatic imaging devices 124 with the capturing of thermal images 404 by the one or more thermal imaging devices 110 facilitates reducing the complexity of generating the DSM and using more data (such as all of the thermal images 404, all or more of the data in the spectral images 406, and all or more of the date in the panchromatic images 403) to generate the DSM. Thus, synchronizing the capturing of spectral images 406 and the panchromatic images 403 with the capturing of thermal images 404 facilitates oversampling of targets by facilitating the ability to use more of the spectral image data and more of the panchromatic image data and the ability to use more thermal images, and may also facilitate generating the DSM using processing resources of the aerial vehicle (e.g., processing core 602 and memory 604 of sensor 112), instead of sending the data to a remote server to generate the DSM, due to faster processing. The increased in accuracy of the modeling facilitates reducing noise in the signal as well as providing higher resolution and clearer measurement results. There may be some tradeoff in reducing noise and providing clearer results in the DSM generation.

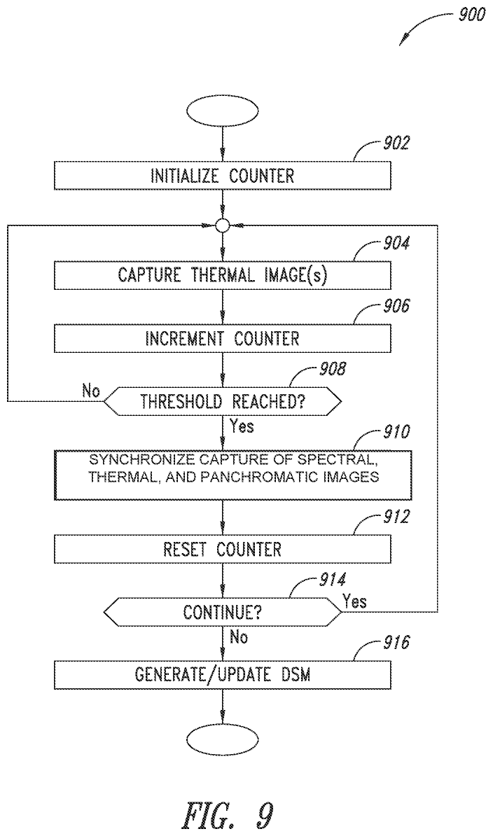

FIG. 9 is a flow chart illustrating one example process 900 of generating and capturing synchronized thermal, spectral, and panchromatic images, and using the images to generate a digital surface model of a target area, such as a field. The process 900 may be performed, for example, by the aerial vehicle 100 of FIG. 1, or the sensor 112 of FIGS. 1-3 and 6.

At 902, the process 900 initializes one or more control variables or devices, such as a counter, the process 900 proceeds from 902 to 904. At 904, the process 900 executes a thermal image capture cycle, capturing a thermal image using a thermal imaging device such as the thermal imaging device 110 of FIG. 6. In some embodiments, additional thermal images may be captured during the thermal image capture cycle of 904 using additional thermal imaging devices. The capturing of the thermal images in the thermal image capture cycle at 904 may be synchronized. The process 900 proceeds from 904 to 906, where the control variables or the counter are updated or incremented to reflect occurrence of a thermal image capture cycle at 904. The process proceeds from 906 to 908.

At 908, the process 900 determines whether the next capture cycle of one or more thermal images should be synchronized with a capture cycle of one or more spectral images and one or more panchromatic images. As illustrated, this is done by determining whether a threshold number of thermal image capture cycles has been reached, for example by comparing a value of a counter to a threshold (e.g., n−1). When it is determined at 908 that the next capture cycle of one or more thermal images should be synchronized with a capture cycle of one or more spectral images and one or more panchromatic images, the process 900 proceeds to 910. When it is not determined at 908 that the next capture cycle of one or more thermal images should be synchronized with a capture cycle of one or more spectral images, the process 900 returns to 904 to execute another thermal image capture cycle.

At 910, the process synchronizes execution of a thermal image capture cycle with execution of a spectral image capture cycle and the panchromatic image capture cycle. The capturing of one or more thermal image(s) using corresponding thermal imaging device(s) is synchronized with the capturing of one or more spectral image(s) by one or more spectral imaging device(s) and is synchronized with the capturing of one or more panchromatic image(s) by the one or more panchromatic imaging device(s). This may be done, for example, by triggering a shutter or shutters of the one or more spectral imaging devices and one or more of the panchromatic imaging devices at the same time as, or within a threshold period of time of the triggering of the thermal image capture cycle. The process 900 proceeds from 910 to 912, where the control variable or counter are reset. The process 900 proceeds from 912 to 914.

At 914, the process 900 determines whether to continue gathering image data. This process 900 may determine whether to continue gathering image data based on control signals, threshold periods of time, buffer statuses, determined acquisition schedules, etc. When it is determined at 914 to continue gathering image data, the process 900 returns to 904. When it is not determined at 914 to continue gathering image data, the process 900 proceeds from 914 to 916.

At 916, the process 900 generates a DSM using the synchronized thermal, spectral, and panchromatic images captured by the thermal, spectral, and panchromatic imaging devices, such as imaging devices of the sensor 112 of FIG. 6. The DSM may be generated, for example, using the sensor 112 of FIGS. 1-3 and 6, the aerial vehicle 100 (e.g., a processing core of the aerial vehicle 100 separate from the sensor 112), by a remote server (not shown), and various combinations thereof. With reference to FIGS. 1-3 and 6, the synchronized images are captured as the aerial vehicle 100 is flown above an area of interest. The multiple images are captured from multiple angles.

The DSM is generated from high-resolution features contained in synchronized multispectral imagery and panchromatic imagery. Photogrammetry techniques may be used to extract geometric information from the spectral images and the panchromatic images to identify the features. Techniques may be employed to account for lens distortions and alignment of the images using, for example, calibration information, feature detection, etc. Using the digital surface models and pose estimates from the multispectral images and the panchromatic images, and a prior or a posteriori relative angular information, the pose of the synchronized thermal imager 110 which captures thermal images at the same time may be estimated. This facilitates using the thermal images with a lower spatial sampling frequency to refine the DSM. The DSM, pose, and camera thermal model information may be used to estimate the temperature of each point on the digital surface model, at a higher resolution than resolution of the thermal pixels of the thermal imager. The radiometric response of each pixel in the imagery may be used to model the emissivity of the object under the pixel. The emissivity information may be used to calibrate each aligned thermal pixel to retrieve a temperature estimate of the surface temperature at that point. For example, the temperature estimate may be retrieved from a look up table. The panchromatic information may be used to accurately align each thermal pixel and each spectral pixel with an appropriate point in the panchromatic image to provide a more accurate DSM as compared to as DSM generated utilizing only the thermal images and the spectral images without the panchromatic images.

Embodiments of the process 900 of FIG. 9 may include more acts than illustrated, may include fewer acts than illustrated, may separate illustrated acts into multiple acts, may combine illustrated acts into fewer acts, and may perform illustrated acts in various orders, which may include performing illustrated acts in parallel or using an iterative process. For example, in an embodiment of the process 900 a parallel process may be employed to simultaneously generate or update the DSM or composite output pixel maps while image capture cycles are being executed. In another example, generating the DSM may be an iterative process, in which images are reprocessed based on the DSM, and the DSM is updated based on the reprocessed images. In another example, the DSM may be generated in a remote server after the aerial vehicle has landed and the stored data has been transferred to the remote server for processing. In some embodiments, the DSM will be generated on the aerial vehicle and in other embodiments, the DSM will be generated after the flight on a separate processing device from the aerial vehicle.

In some embodiments, the composite pixel map may be based on data from the thermal, spectral, and panchromatic images. For example, the spectral images and panchromatic images may be used to create the DSM and the spectral images may be used to estimate the emissivity of the pixels. Then the thermal information may provide the underlying value of the pixels for the composite pixel map. The panchromatic images may be utilized to collate positioning of pixels of the spectral images and the thermal images to provide a more accurate positioning of the thermal information and the spectral information for the pixels of the composite pixel map. In other words, the

In another example, the process 900 may be modified to capture background irradiance data using one or more irradiance sensing devices, such as the irradiance sensing device 130 of FIGS. 1 and 7. The capturing of irradiance data may be synchronized, for example, with each thermal image capture cycle, with each synchronized thermal and spectral image capture cycle, etc. A downwelling light sensor measures both the angle and diffusivity ratio of light paths, and a model of the hemispherical incoming irradiance derived are used to estimate the temperature of the sky. The estimated temperature of the sky may be used to correct the surface temperatures measurements using the emissivity, sky temperature, and measured pixel temperature. Measuring the irradiance of the sky facilitates a more accurate estimation of the temperature because it provides an indication of what portion of the radiation emitted by a surface is reflected, and thus allows for a better estimate of the material of the surface. The temperature of the sky can be subtracted from the measured temperature. For example, the emissivity of a tin roof can be estimated with a reflective curve, and a lookup table based on the relationship of reflectance to emissivity plus the temperature of the sky may be used to estimate the temperature. An estimate of the emissivity may be corrected based on the temperature of the sky, and then the thermal information may be corrected. This may be done on a pixel by pixel basis. Drones are closer to the ground than satellites and have bigger pixels than spectral images and panchromatic images captured utilizing a satellite, which may further facilitate providing more accurate temperatures projected on the DSM and more accurate positioning of pixels in the DSM.

In another example, the process 900 may be modified to capture inertial motion data using one or more IMUs, such as the IMU 610 of FIG. 6, and to use the inertial motion data to estimate the pose of images captured by the sensor, such as thermal images captured by the thermal imaging devices 110 of FIG. 6. The capturing of inertial motion data may be synchronized, for example, with each thermal image capture cycle, with each synchronized thermal, spectral, and panchromatic image capture cycle, etc. The pose of each sequential thermal image captured by a thermal camera may be estimated by using the derived pose of synchronized captures from a visible camera. When the IMU includes a gyroscope the gyroscope may provide change in angle information, which may be integrated over a set of adjacent images. When the IMU includes accelerometer, the accelerometer may provide change in position information, which may typically not be integrated over adjacent images. The IMU data may be used to determine inter-frame pose change, and photogrammetry or image matching may be used to determine the pose changes and absolute pose of the visible imagery.

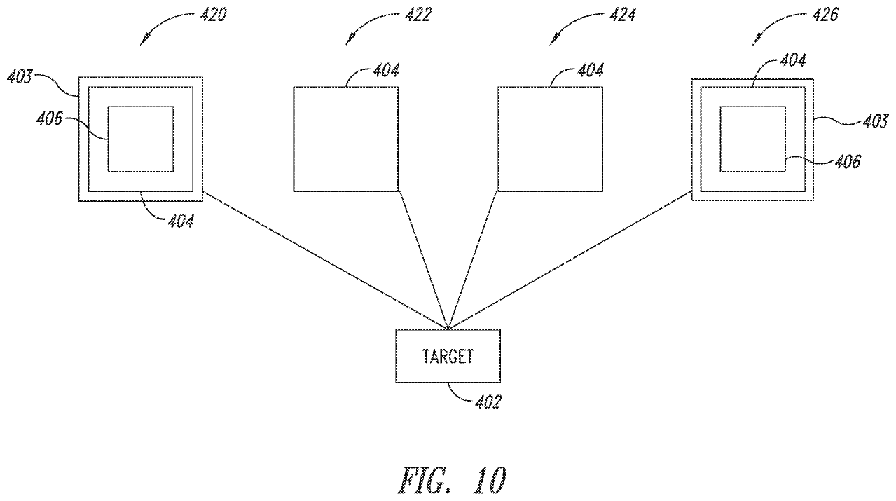

With reference to FIG. 10, a synchronized image capture cycle 420 captures a spectral image 406, and a panchromatic image 403 of a target synchronized with the capturing of a thermal image 404 of the target. Subsequent image capture cycles 422 and 424 capture respective thermal images 404 of the target, then synchronized image capture cycle 426 captures a spectral image 406 and a panchromatic image 403 of the target synchronized with a thermal image 404 of the target. The pose (position and orientation) of the target 402 or point on the target 402 with respect to the thermal imaging devices 110 when image capture cycles 422 and 424 are executed may be estimated based on the IMU data and the pose estimates for image capture cycle 420. In an embodiment, the estimated poses at cycles 422 and 424 may also be based on the pose estimates for cycle 426. In an embodiment, other position information may also be considered, such as GPS information. In an embodiment, the thermal image data of images in a sequence of thermal images may be applied to estimate the pose of images captured at image capture cycles 422 and 424 before consideration of the spectral image data due to the lower resolution of the thermal images. Then spectral image data (oversampled) may be applied if further refinement of the estimated pose is desired. There may be some tradeoff in reducing the noise in measurements and improving the signal resolution in the estimated pose.

The DSM, data gathered by the sensor (e.g., the spectral images, the thermal images, the panchromatic images, any irradiance data, any accelerometer data, etc.), external or known data (e.g., GPS data, flight paths, etc.), may be used to characterize pixels of a composite output map generated based on the DSM. Captured images are projected onto the DSM based on camera position information. The information for a single point is projected from multiple angles by the multiple images. A pixel of the output map may be characterized, for example, as soil, shadow, plants, etc. The output pixel map may be used, for example, together with temperature information to identify issues which may need to be addressed.

For example, using the classified pixels of the output map, areas where the soil temperature or shadow temperature is statistically different and lower than the surrounding soil or shadowed areas may indicate areas where irrigation leaks are occurring. In another example, high resolution spectral images, temperature information, and high resolution panchromatic images may be used to identify distressed plants, such as grape vines in a field. For example, the human eye can detect stress 14 days after a plant experiences the stress. In an embodiment, high resolution spectral images using oversampling may detect plant stress within 5-6 days of the stress occurring. When combined with thermal mapping, the detection time frame may be reduced even further. In an embodiment, the oversampled thermal mapping can measure a 0.5 degrees Celsius change in temperature.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

Embodiments of the present disclosure include a device that includes thermal imaging circuitry, which, in operation, executes a sequence of thermal image capture cycles to capture a sequence of thermal images, spectral imaging circuitry, which, in operation, executes a sequence of spectral image capture cycles to capture a sequence of spectral images, and panchromatic imaging circuitry, which, in operation, executes a sequence of panchromatic image capture cycles to capture a sequence of panchromatic images. The device includes control circuitry, coupled to the thermal imaging circuitry, coupled to the spectral imaging circuitry, and coupled to the panchromatic imaging circuitry, where the control circuitry, in operation, synchronizes execution of spectral image capture cycles by the spectral imaging circuitry and execution of panchromatic image capture cycles by the panchromatic imaging circuitry with execution of thermal image capture cycles by the thermal imaging circuitry. These may all be included on an aerial vehicle in fixed position with respect to each other.

The device includes one or more additional spectral imaging circuits and one or more additional panchromatic imaging circuits, where the control circuitry, in operation, synchronizes execution of spectral image capture cycles by the one or more additional spectral imaging circuits with the execution of the thermal image capture cycles by the thermal imaging circuitry, and, where the control circuitry, in operation, synchronizes execution of panchromatic capture cycles by the one or more additional panchromatic imaging circuits with the execution of the thermal image capture cycles by the thermal imaging circuitry. The device includes the spectral image circuity and the one or more additional spectral image circuits have a common shutter. The control circuitry, in operation, generates a digital surface model based on the sequence of spectral images or generates the digital surface model based on the sequence of thermal images.

In other variations, the control circuitry, in operation, generates a composite pixel map of an area of interest based on the digital surface model. The control circuitry, in operation, identifies distressed plants based on the composite pixel map. The distress plants may be identified from a variety of plant properties, such as leaf color, temperature, and size and growth.

The control circuitry, in operation, can estimate temperatures of pixels or groups of pixels in the composite pixel map. The control circuity, in operation, estimates pixel conditions based on the composite pixel map and the estimated temperatures. In addition, the control circuitry, in operation, identifies plant properties based on the composite pixel map and the estimated temperatures. The device can be an aerial vehicle having a first surface and a second surface opposite the first surface, the aerial vehicle including an irradiance detection device on the first surface, the thermal and spectral imaging devices being on the second surface. In embodiments, the control circuity synchronizes the spectral image capture cycle with every other thermal image capture cycle. The control circuitry, in operation, identifies conditions consistent with an irrigation leak based on the estimated pixel conditions.

In other embodiments, the present disclosure is directed to a method that includes executing, by a thermal imaging device, a sequence of thermal image capture cycles to capture a sequence of thermal images, synchronizing execution, by a spectral imaging device, of spectral image capture cycles to capture a sequence of spectral images with execution of thermal image capture cycles by the thermal imaging device, synchronizing execution, by a panchromatic imaging device, of panchromatic image capture cycles to capture a sequence of panchromatic images with execution of the thermal image capture cycles by the thermal imaging device, and generating a digital surface model of an area of interest based on the sequence of spectral images and the sequence of panchromatic images. The method includes synchronizing execution of spectral image capture cycles by a plurality of spectral imaging devices with the execution of the thermal image capture cycles by the thermal imaging circuitry. The digital surface model is based on the sequence of thermal images. The method also includes generating a composite pixel map of the area of interest based on the digital surface model and can identify distressed plants based on the composite pixel map.

The method includes estimating temperatures of pixels or groups of pixels in the composite pixel map. The method includes estimating pixel conditions based on the composite pixel map and the estimated temperatures. The method also includes identifying irrigation leaks based on the pixel occupancy map and the estimated temperatures. In embodiments, the method includes projecting thermal data onto the digital surface model in response to the sequence of thermal images. The method can store the sequence of thermal images, the sequence of spectral images, and the sequence of panchromatic images, a number of the sequence of thermal images being greater than a number of the sequence of spectral images and greater than a number of the sequence of panchromatic images.

Other embodiments include identifying an object in a first one of the spectral images and a first one of the panchromatic images and a second one of the spectral images and a second one of the panchromatic images, identifying first location information associated with the first ones of the spectral images and the panchromatic images and second location information associated with the second ones of the spectral images and the panchromatic images, and generating the digital surface model from at least the first and second ones of the spectral and panchromatic images with the first and second location information. The method may include identifying the object in at least two of the thermal images of the sequence of thermal images by associating a capture time of the first ones and the second ones of the spectral and panchromatic images with the thermal images of the sequence of thermal images, identifying a measurement for the object for each thermal image, projecting the measurement for the object for each thermal images onto the digital surface model.

Another embodiment includes capturing a plurality of thermal images from a thermal imaging device on an aerial vehicle, the capturing having a first frequency of capture, capturing a plurality of spectral images from a spectral imaging device on the aerial vehicle, the capturing having a second frequency of capture that is less than the first frequency of capture, capturing a plurality of panchromatic images from a panchromatic imaging device on the aerial vehicle, the capturing having the second frequency of capture, synchronizing a shutter of the spectral imaging device and a shutter of the panchromatic imaging device with the shutter of the thermal imaging device at the second frequency of capture, and generating a digital surface model representative of depth information and location information of an environment being imaged based on the plurality of spectral images and the plurality of panchromatic images. The method includes generating a high resolution thermal overlay of the digital surface model by identifying a physical object imaged in the plurality of spectral images and the plurality of panchromatic images, depth information of the physical object being presented as a point in the digital surface model, identifying a subset of the plurality of thermal images by aligning the first frequency of capture with the synchronized second frequency of capture, identifying the object in the subset of the plurality of thermal images, identifying a plurality of thermal information data measurements regarding the object in the subset of the plurality of thermal images, and projecting the plurality of thermal information data measurements onto the point associated with the object in the digital surface model.

The present disclosure is also directed to a device that includes thermal imaging circuitry, which, in operation, executes a sequence of thermal image capture cycles to capture a sequence of thermal images, spectral imaging circuitry, which, in operation, executes a sequence of spectral image capture cycles to capture a sequence of spectral images, panchromatic imaging circuitry, which, in operation, executes a sequence of panchromatic capture cycles to capture a sequence of panchromatic images, inertial motion sensing circuitry, which, in operation, generates data indicative of relative movement of the device, and control circuitry, coupled to the thermal imaging circuitry, to the spectral imaging circuitry, to the panchromatic imaging circuitry, and to the inertial motion sensing circuitry. The control circuitry, in operation: synchronizes execution of spectral image capture cycles by the spectral imaging circuitry and synchronizes execution of panchromatic image capture cycles by the panchromatic imaging circuitry with execution of thermal image capture cycles by the thermal imaging circuitry and estimates a pose of a thermal image of the sequence of thermal images based on the data indicative of relative movement of the device.

The inertial motion sensing circuitry may be an accelerometer or a gyroscope. The control circuitry, in operation, generates a digital surface model based on the sequence of spectral images. The control circuitry, in operation, generates a digital surface model based on the sequence of panchromatic images. The control circuitry, in operation, generates the digital surface model based on the sequence of thermal images. The control circuitry, in operation, generates the digital surface model based on the estimated pose of the thermal image.

An alternative embodiment is directed to a method that includes executing, by a thermal imaging device, a sequence of thermal image capture cycles to capture a sequence of thermal images, synchronizing execution, by a spectral imaging device, of spectral image capture cycles to capture a sequence of spectral images with execution of thermal image capture cycles by the thermal imaging device, synchronizing execution, by a panchromatic imaging device, of panchromatic image capture cycles to capture a sequence of panchromatic images with execution of the thermal image capture cycles by the thermal imaging device, capturing inertial motion data with an inertial motion sensor, estimating a pose of a thermal image in the sequence of thermal images based on the captured inertial motion data, and generating a digital surface model of an area of interest based on the sequence of spectral images and the sequence of panchromatic images. The thermal imaging device, the spectral imaging device, and the inertial motion sensor are fixed with respect to each other on an aerial device. The method includes capturing depth, location, and thermal information about the area with the thermal imaging device, the spectral imaging device, and the panchromatic imaging device. The method also includes identifying an object from the area in the sequence of spectral images and the sequence of panchromatic images, generating a point on the digital surface model representative of the object based on the sequence of spectral images and the sequence of the panchromatic images, generating a plurality of thermal measurements from the sequence of thermal images associated with the object, projecting each of the plurality of thermal measurements on the point on the digital surface model.

The method further includes correlating the plurality of thermal measurements from the sequence of thermal images by associating the inertial measurement data with each thermal image. It may also include capturing inter-frame location information with the inertial measurement data and correlating the inter-frame location information with each thermal images of the sequence of thermal images.

Another embodiment is a device or unmanned aerial vehicle that includes thermal imaging circuitry, which, in operation, executes a sequence of thermal image capture cycles to capture a sequence of thermal images, spectral imaging circuitry, which, in operation, executes a sequence of spectral image capture cycles to capture a sequence of spectral images, panchromatic imaging circuitry, which, in operation, executes a sequence of panchromatic image capture cycles to capture a sequence of panchromatic images, and control circuitry, coupled to the thermal imaging circuitry, to the spectral imaging circuitry, and to the panchromatic circuitry. The control circuitry, in operation gathers irradiance data indicative of a background temperature, synchronizes execution of spectral image capture cycles and panchromatic images capture cycles by the spectral imaging circuitry and the panchromatic imaging circuitry, respectively, with execution of thermal image capture cycles by the thermal imaging circuitry, generates a digital surface model based on the sequence of spectral images and the sequence of panchromatic images, estimates an emissivity of a target, and estimates a temperature of a pixel of the digital surface model based on the sequence of thermal images, the irradiance data indicative of the background temperature and the estimated emissivity of the target.

The irradiance sensing circuitry includes a plurality of photo sensors. The plurality of photo sensors are configured to simultaneously sense irradiance from a light source, where the light source is the sun. The irradiance sensing circuitry, which, in operation, senses irradiance data indicative of the background temperature. The control circuitry gathers the irradiance data from an irradiance model based on environmental conditions. The control circuitry gathers the irradiance data from an irradiance model based the sequence of spectral images. The control circuitry gathers the irradiance data from an irradiance model based the sequence of thermal images. The control circuitry gathers irradiance data from an irradiance model based on the sequence of panchromatic images. The control circuitry gathers the irradiance data from an irradiance model based the sequence of spectral images and the sequence of thermal images. The control circuitry may gather the irradiance data from an irradiance model based the sequence of spectral images, the sequence of thermal images, and the sequence of panchromatic images.

Another method includes capturing a sequence of thermal images with thermal imaging circuitry by executing a sequence of thermal image capture cycles, capturing a sequence of spectral images with spectral imaging circuitry by executing a sequence of spectral image capture cycles, capturing a sequence of panchromatic images with panchromatic imaging circuitry by executing a sequence of panchromatic image capture cycles, and processing the sequence of spectral images, the sequence of thermal images, and the sequence of panchromatic images with control circuitry coupled to the thermal imaging circuitry, coupled to the spectral imaging circuitry, and coupled t the panchromatic imaging circuitry. The processing includes estimating irradiance data indicative of a background temperature, synchronizing the capturing of the spectral image capture cycles by the spectral imaging circuitry and the capturing of the panchromatic image capture cycles by the panchromatic imaging circuitry with the capturing of thermal image capture cycles by the thermal imaging circuitry, the capturing of the thermal image capture cycles being more frequent than the spectral image capture cycles and the panchromatic image capture cycles, generating a digital surface model based on the sequence of spectral images and the panchromatic images, estimating an emissivity of a target, and estimating a temperature of a pixel of the digital surface model based on the sequence of thermal images, the irradiance data indicative of the background temperature and the estimated emissivity of the target.

The method includes the estimating of the irradiance data includes capturing irradiance data with an irradiance data capture device positioned on a first surface of an aerial vehicle, the spectral imaging circuitry and the thermal imaging circuitry being on a second surface of the aerial vehicle that is opposite to the first surface. The method includes the estimating of the irradiance data includes capturing irradiance data with an irradiance data capture device positioned facing a first direction, the spectral imaging circuitry and the thermal imaging circuitry positioned facing a second direction that is different from the first direction. The estimating of the emissivity includes generating the irradiance data from the spectral images. The estimating of the emissivity includes generating the irradiance data from the thermal images. The estimating of the emissivity includes generating the irradiance data from the spectral images and the thermal images. In some embodiments, the panchromatic data from the panchromatic images may be utilized along with the spectral images and the thermal images to generate the irradiance data.

The disclosure also includes a method of executing, by a thermal imaging device, a sequence of thermal image capture cycles to capture a sequence of thermal images; synchronizing execution, by a spectral imaging device, of spectral image capture cycles to capture a sequence of spectral images with execution of thermal image capture cycles by the thermal imaging device; synchronizing execution, by a panchromatic imaging device, of panchromatic image capture cycles to capture a sequence of panchromatic images with execution of the thermal image capture cycles of the thermal imaging device; sensing irradiance data indicative of a background temperature; generating a digital surface model based on the sequence of spectral images and the sequences of panchromatic images; estimating an emissivity of a target; and estimating a temperature of a pixel of the digital surface model based on the sequence of thermal images, the irradiance data indicative of the background temperature and the estimated emissivity of the target.

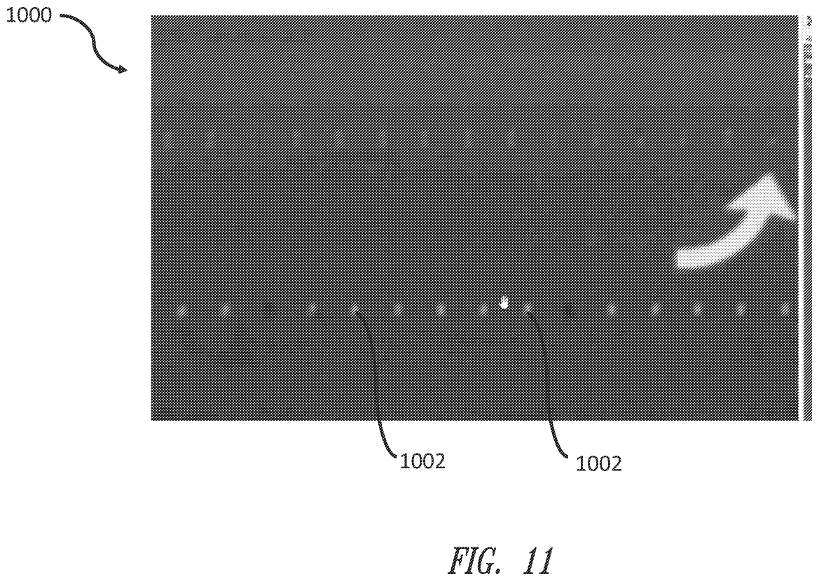

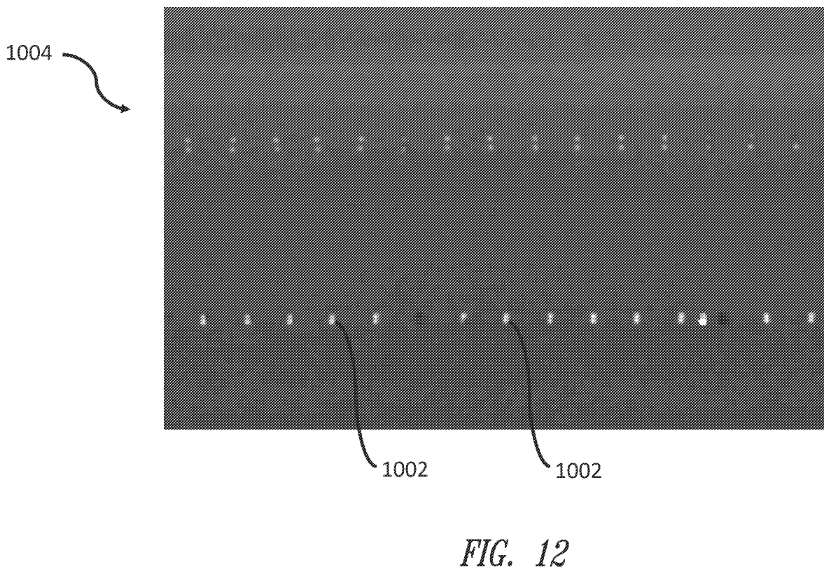

FIG. 11 is directed to a multispectral image 1000 determined utilizing spectral images captured by the spectral imaging devices 120 when the aerial vehicle 100 is at an elevation of 400-ft. As shown in FIG. 11, street markers 1002 have been captured in the multispectral image 1000. These street markers 1002 may have a height of about 3-inches. While the street markers 1002 are generally identifiable within the multispectral image 1000, if distinct objects in a more cluttered arrangement were within the multispectral image, a processor or user would likely have difficulties in identifying individual ones of the distinct objects. Indeed, as will be discussed below with respect to FIG. 12, each of the street markers 1002 shown in FIG. 11 actually includes two separate street markers. Crops on a plant such as corn, apples, etc. may be more difficult to identify due to the blurriness of these distinct objects within a multispectral image.

FIG. 12 is directed to an image 1004 sharpened by collating a multispectral image determine utilizing spectral images captured by the spectral imaging devices 120 and panchromatic images captured by the panchromatic imaging device 124 when the aerial vehicle 100 is at an elevation of 400-ft. The scene shown in FIG. 12 is the same scene as depicted in FIG. 11; however, the image shown in FIG. 12 is generated as a pan-sharped multispectral image which was acquired by an imaging device including multispectral image sensors and a panchromatic image sensor, as described in various embodiments herein.

As shown in FIG. 12, the street markers 1002 have been captured in the image 1004, which is a pan-sharpened multispectral image in which the panchromatic images are utilized to sharpen the multispectral image, such that the street markers 1002 are sharper and more easily identifiable as compared to the street markers 1002 as shown in FIG. 11. This clearer and more identifiable street markers 1002 allows for the processor to more readily count the number of street markers within the image 1004 more accurately and precisely as compared to the street markers 1002 as shown in FIG. 11. In fact, as can be seen from FIG. 12, each of the street markers 1002 discernible in FIG. 11 actually include two separate street markers 1002 which are arranged in close proximity to one another. Each of the two street markers 1002 of the closely positioned pairs of street markers may be distinctly identified and counted based on the image generated as shown in FIG. 12. In view of this discussion, when distinct objects are in a more cluttered configuration such as crops on plants or plants within an agricultural field that may partially overlap with each other, the processor may more readily count the number of crops or the number of plants as a cleaner and sharper image is processed by the processor. The collation of the spectral images and the panchromatic images improves the accuracy and speed at which the processor may be able to count the number of distinct objects (e.g., street markers, trees, plants, crops, corn, apples, etc.).

For example, the distinct objects (e.g., street markers, trees, plants, crops, corn, apples, etc.) may be counted by an embodiment of a method of counting, which includes capturing a plurality of spectral images with the plurality of spectral imaging devices, capturing a panchromatic image with the panchromatic imaging device 124, and capturing thermal images with the thermal imaging devices 110. The spectral images, the panchromatic images, and the thermal images may be captured simultaneously with each other. The spectral images may be utilized either by themselves or along with the thermal images to determine a multispectral image of the area in which the distinct objects are present to be counted. The multispectral image may then be pan-sharpened utilizing the panchromatic images captured by the panchromatic imaging device 124. Pan-sharpening the multispectral image enhances the resolution of the multispectral image such that a processor may readily and easily count the number of distinct objects within the pan-sharpened multi-spectral image. The processor may then output the number of distinct objects counted to a display that is readily visible by an individual, which may be operating the aerial vehicle 100 to scan the area to count the number of distinct objects. For example, the individual may be flying the aerial vehicle over an agricultural field to count the number of crops or plants within the agricultural field. Alternatively, the individual may be flying the aerial vehicle 100 over a forest to count the number of trees present within an area of the forest. In other words, the aerial vehicle 100 along with the sensor 112 may be utilized to count any number of distinct objects within an area to be scanned by the aerial vehicle 100 utilizing the sensor 112.

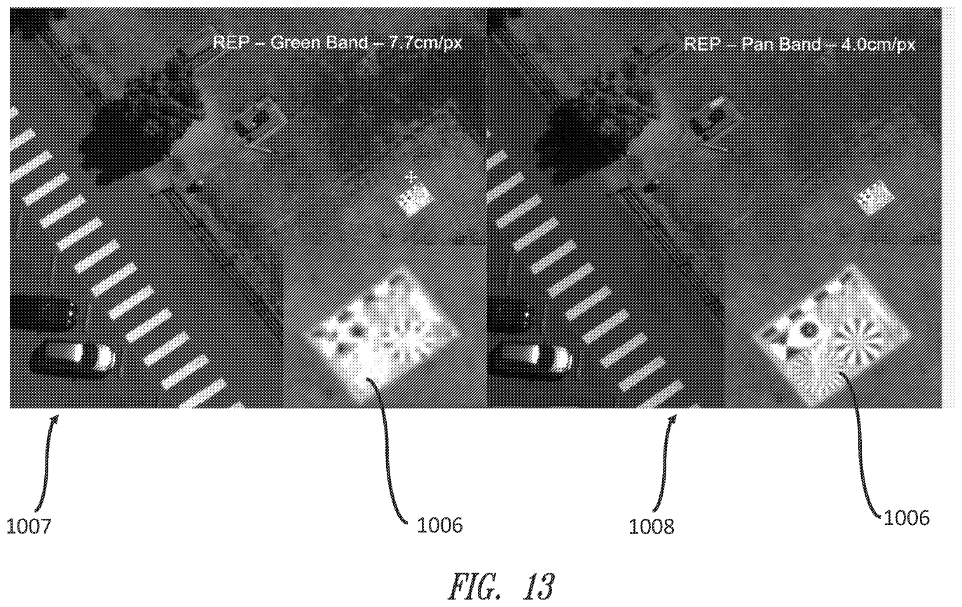

FIG. 13 illustrates a green band image 1007 (e.g., as may be acquired by a multispectral imager directed to wavelengths in the green color range) on the left-hand side which has a 7.7-centimeter/pixel resolution, whereas a pan band image 1008 (e.g., as may be acquired by a panchromatic imager) on the right-hand side has a 4.0-centimeter/pixel resolution. As one zooms in on a resolution test feature 1006 (which may be, for example, a Siemens star, spoke target, or other such optical instruction resolution testing feature) in at the right-hand side of the green band image, details of the resolution test feature 1006 are not readily distinguishable or identifiable. The resolution test feature 1006 may be a marker that may be utilized to test or calibrate resolution of images acquired from an aerial position. Alternatively, as the pan band image, which may be a panchromatic image acquired by the panchromatic imager or may be an image generated by collating a multispectral image and one or more panchromatic images (e.g., pan-sharpening), the details of the resolution test feature 1006 are readily distinguishable and identifiable as an individual may more readily see black triangles and black squares representing details such as color of the feature 1006. This allows the processor to perform ever increasingly complex functions even when analyzing small features due to the increased resolution in the pan band image as compared to the green band image.

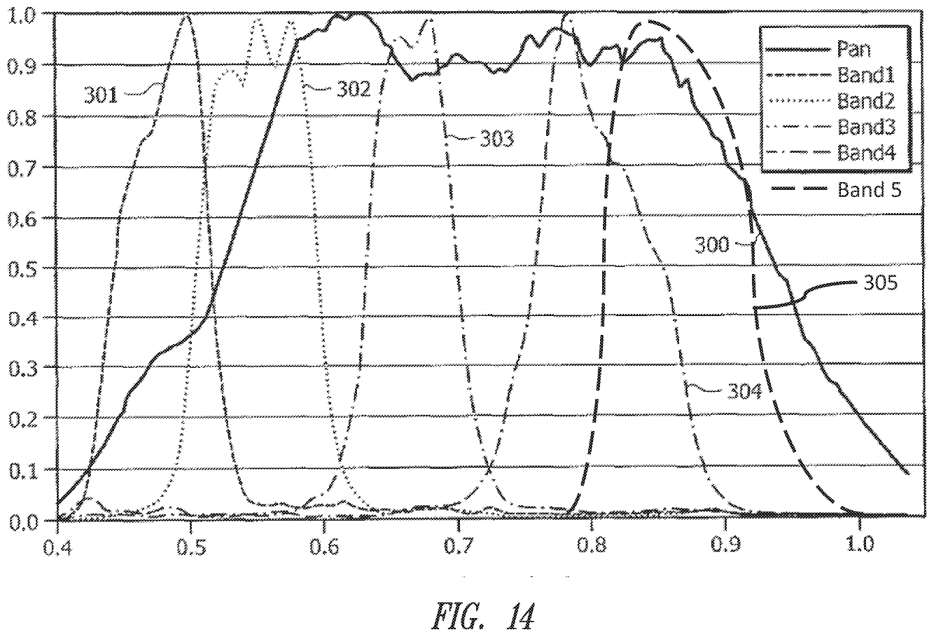

FIG. 14 is an illustration showing a graph including wavelength bands of the spectral imaging devices 120 and the panchromatic imaging device 124 of the sensor 112, which may be mounted to the aerial vehicle 100. A first one of the spectral imaging devices 120 includes a first band 301 of wavelengths. A second one of the spectral imaging devices 120 includes a second band 302 of wavelengths. A third one of the spectral imaging devices 120 includes a third band 303 of wavelengths. A fourth one of the spectral imaging devices 120 includes a fourth band 304 of wavelengths. A fifth one of the spectral imaging devices 120 includes a fifth band 305. The panchromatic imaging device 124 includes a sixth band 300 that overlaps all of the first, second, third, fourth, and fifth bands 301, 302, 303, 304, 305 of the spectral imaging devices 120. In other words, the panchromatic imaging device 124 receives either some or all of the wavelengths within each one of the first, second, third, fourth, and fifth bands 301, 302, 303, 304, 305. While in the graph only one panchromatic imaging device is shown, there may be more than one panchromatic imaging devices. For example, the sensor 112 may include more than one of the panchromatic imaging devices 124 such that the aerial vehicle 100 includes more than one of the panchromatic imaging devices 124.

In view of the graph, each one of the spectral imaging devices 120 is directed to a distinct wavelength range that is different from other ones of the spectral imaging devices 120. As shown in FIG. 14, the distinct wavelength ranges of the spectral imaging devices 120 may overlap with each other, and all of the wavelength ranges of the spectral imaging devices 120 overlap with the wavelength range of the panchromatic imaging device 124. In some embodiments, the distinct wavelength ranges of the spectral imaging devices 120 may not overlap with each other and each one of the distinct wavelength ranges may instead only overlap with the wavelength range of the panchromatic imaging device 124.

The distinct wavelength ranges may be determined by applying filters to the spectral imaging devices 120 and to the panchromatic imaging device 124. For example, each one of the spectral imaging devices 120 may include a filter that allows for a distinct wavelength range to be captured by each one of the spectral imaging devices 120. In other words, each one of the spectral imaging devices 120 may have a different filter. A first one of the spectral imaging devices 120 may have a filter such that the first one captures red light bands, a second one of the spectral imaging devices 120 may have a filter such that the second one captures green light bands, a third one of the spectral imaging devices 120 may have a filter such that the third one capture blue light bands, a fourth one of the spectral imaging devices 120 may have a filter such that the fourth one captures infrared light bands, and a fifth one of the spectral imaging devices 120 may have a filter such that the fifth one captures red edge light bands. For example, the panchromatic imaging device 124 include a filter that allows for a wavelength range overlapping all of the distinct wavelength ranges captured by the spectral imaging devices 120

When an individual is operating (e.g., flying) the aerial vehicle 100 to count a number of distinct objects within an area, the operated may fly the aerial vehicle 100 along a path such that each spectral image overlaps 75% with other spectral images captured by the spectral imaging devices 120, each thermal image overlaps 75% with other thermal images captured by the thermal imaging devices 110, and each panchromatic image overlaps 75% with other panchromatic images captured by the panchromatic imaging device 124.

In view of the discussion above, ones of the panchromatic images, the spectral images, the thermal images, and the irradiance information in various combinations may be utilized to generate a 3D models due to the high resolution of the panchromatic images as compared to the spectral images and the thermal images.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Non-Provisional patent application Ser. No. 17/299,258, filed on Jun. 2, 2021, U.S. Non-Provisional patent application Ser. No. 16/037,952, filed on Jul. 17, 2018, and U.S. Provisional Patent Application No. 63/240,730, filed on Sep. 3, 2021, are incorporated herein by reference, in their entirety. Aspects of the embodiments can be modified, if necessary to employ concepts of the various embodiments and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a housing including a base portion and a lens portion extending from the base portion;
one or more spectral imaging devices within the housing;
one or more panchromatic imaging devices within the housing; and
one or more processors coupled to the one or more spectral imaging devices, the one or more panchromatic imaging devices, and the one or more thermal imaging devices.

2. The device of claim 1, further comprising one or more digital storage devices coupled to the processor and configured to store image information captured from the one or more spectral imaging devices and the one or more panchromatic imaging devices.

3. The device of claim 1, further comprising one or more thermal imaging devices within the housing, the one or more processors being coupled to the one or more thermal imaging devices.

4. A method, comprising:
processing multispectral image information acquired simultaneously by a plurality of spectral imaging devices, each of the spectral imaging devices being directed to a distinct wavelength range, the distinct wavelength ranges being non-overlapping with respect to one another;
processing panchromatic image information acquired by a panchromatic imaging device simultaneously with the multispectral image information, the panchromatic imaging device being directed to a collective wavelength range overlapping each one of the distinct wavelength ranges of the plurality of spectral imaging devices;
processing irradiance information from a downwelling light sensor (DLS) simultaneously with the panchromatic image information and the multispectral image information; and
generating an image of an area with a resolution of less than 5-centimeters per pixel based on the processed multispectral image information, the processed panchromatic image information, and the processed irradiance information.

5. A method, comprising:
processing multispectral image information acquired simultaneously by a plurality of spectral imaging devices, each of the spectral imaging devices being directed to a distinct wavelength range;
processing panchromatic image information acquired by a panchromatic imaging device simultaneously with the multispectral image information, the panchromatic imaging device being directed to a collective wavelength range overlapping each one of the distinct wavelength ranges of the plurality of spectral imaging devices;
processing irradiance information from a downwelling light sensor (DLS) simultaneously with the panchromatic image information and the multispectral image information;
generating an image of an area with a resolution of less than 5-centimeters per pixel based on the processed multispectral image information, the processed panchromatic image information, and the processed irradiance information; and
classifying pixels within the image to two or more classes using the combined spectral and panchromatic image information,
using the classified pixels for counting a number of distinct objects within the image.

6. The method of claim 5, wherein the distinct objects are plants.

7. The method of claim 5, wherein the combined spectral and spatial information from the generated image is used for counting the number of distinct objects within the image.

8. A method, comprising:
counting a plurality of plant components in an area by:
processing multispectral image information from a plurality of multispectral imagers, each of the multispectral imagers being directed to a distinct wavelength range, the ranges being non-overlapping with each other, the multispectral image information being acquired by the plurality of multispectral imagers while attached to an unmanned aerial vehicle flying at a height of less than 400 feet from the plurality plant components in the area;
processing panchromatic image information from a panchromatic imager, the panchromatic image information being acquired simultaneously with the plurality of multispectral images, the panchromatic imager being directed to the collective wavelengths of the multispectral imagers; and
generating an image of the area based on the processed multispectral image information and the panchromatic image information.

9. A system, comprising:
an unmanned aerial vehicle;
an image acquisition device coupled to the unmanned aerial vehicle, the image acquisition device including:
a plurality of spectral imaging devices, each of the spectral imaging devices being directed to a distinct wavelength range;
a panchromatic imaging device, the panchromatic imaging device facing a same direction as each of the plurality of spectral imaging devices, the panchromatic imaging device being directed to a collective wavelength range overlapping each one of the distinct wavelength ranges of the plurality of spectral imaging devices; and
an irradiance sensor coupled to the unmanned aerial vehicle, the irradiance sensor including a plurality of photo sensors, each of the photo sensors facing a different direction than the panchromatic imaging device and the plurality of spectral imaging devices.

10. The system of claim 9, further comprising a processor configured to:
process multispectral image information acquired simultaneously by the plurality of spectral imaging devices;
process panchromatic image information acquired by the panchromatic imaging device simultaneously with the multispectral image information;
process irradiance information acquired by the irradiance sensor simultaneously with the panchromatic image information and the multispectral image information; and
generate an image of an area with a resolution of less than 5-centimeters per pixel based on the processed multispectral image information, the processed panchromatic image information, and the processed irradiance information.

11. The system of claim 10, wherein the processor is further configured to count a number of distinct objects within the image.
